(19) United States
(12) Patent Application Publication
(10) Pub. No.: US 2002/0087681 A1
(43) Pub. Date: Jul. 4, 2002

(54) Co-evaluation system for component of electronic device

(76) Inventors: Kenichi Kishi, Kawasaki (JP); Hiromasa Kimura, Kawasaki (JP); Takeshi Yabuta, Kawasaki (JP); Masaru Seita, Kawasaki (JP); Yujiro Yoshida, Kawasaki (JP); Kazumasa Moriya, Kawasaki (JP)

Correspondence Address: STAAS & HALSEY LLP, 700 11TH STREET, NW, SUITE 500, WASHINGTON, DC, 20001, US

(21) Appl. No.: 09/924,607

(22) Filed: Aug. 9, 2001

(30) Foreign Application Priority Data
Dec. 28, 2000 (JP) 2000-401971

(51) Int. Cl. G06F 15/173; G06F 15/16

(52) U.S. Cl. 709/224; 709/203

(57) ABSTRACT

A server displays a co-evaluation request containing an evaluation scheme of a first component user on a homepage. A second component user browsing this co-evaluation request through a terminal device transmits a proportion of user's own assignment as an answer to the server. The server displays the proportion of assignment of the second component user on the homepage. Thereafter, each of the first component user and the second component user transmits an evaluation result of the co-evaluation to the server. The server displays each evaluation result received on the homepage. The first and second component users exchange the evaluation results through the homepage, and can share the co-evaluation results on the homepage.

### BACKGROUND OF THE INVENTION

1. Field of the Invention

The present invention relates to a co-evaluation system for a component of an electronic device.

2. Description of the Related Art

A set maker (vendor who will hereinafter be called a [component user]) of an electronic device such as a personal computer, purchases from a supplier (component supplier) a component such as a hard disk drive (HDD), a microprocessor etc mounted in the electronic device as a product.

The component user, when incorporating the component into the electronic device, must assure that an occurrence probability of a trouble of the component in a product field (using environment) is equal to or smaller than a fixed value.

Therefore, the component user, when judging whether the component is adopted or not, sets evaluation conditions and evaluation items, and evaluates a predetermined number of component samples. At this time, for example, if an evaluation result of disqualification occurs in such a number of samples that the component concerned should be treated impossible of its being adopted, the component user demands an improvement of the component of the supplier. The probability at which the trouble of the evaluation target component occurs in the field, can be calculated at a higher accuracy with a larger number of samples of the evaluation target component and a greater number of evaluation items.

There is, however, a limit in the contents of the evaluation that can be implemented by one component user due to a cost needed for the evaluation such as evaluation steps etc and a constraint of an evaluation period etc. On the other hand, according to the prior art, the component was evaluated independently by each component user, and it never happened that the component user cooperate with each other.

### SUMMARY OF THE INVENTION.

It is a primary object of the present invention to provide a co-evaluation system for a component of an electronic device, wherein a plurality component users co-evaluate the component and share a result obtained from the evaluation.

To accomplish the above object, according to one aspect of the present invention, a co-evaluation system for a component of an electronic device comprises a first terminal device used by a first component user who evaluates the component of the electronic device, and a second terminal device used by a second component user. The first terminal device transmits to a network a co-evaluation request containing an evaluation scheme of a specified component that is effected by the first component user. The second terminal device receives the co-evaluation request via the network, and transmits to the network an answer to the co-evaluation request containing the evaluation scheme of the specified component that is effected by the second component user. The first terminal device receives the answer via the network, and transmits to the network an evaluation result of the specified component on the basis of the co-valuation request by the first component user. The second terminal device receives from the network the evaluation result of the specified component by the first component user, and transmits to the network the evaluation result of the specified component based on the co-evaluation request by the second component user. The first terminal device receives the evaluation result of the specified component by the second component user from the network.

According to the present invention, the plurality of component users co-evaluate the component and can share the results obtained from the co-evaluation. Therefore, the component users share evaluation steps and a cost for the evaluation, and are capable of evaluating the component at a higher accuracy of assurance.

### BRIEF DESCRIPTION OF THE DRAWINGS

FIG. 1 is a diagram showing a constitution of a co-evaluation system for a component of an electronic device;

FIG. 2 is a diagram showing a constitution of a Web server shown in FIG. 1;

FIG. 3 is a diagram showing a constitution of a terminal device shown in FIG. 1;

FIGS. 4A and 4B show a flowchart of a co-evaluation alliance homepage;

FIG. 5 is a diagram showing an example of a screen display of a category selection page;

FIG. 6 is a diagram showing an example of a screen display of an evaluation state page;

FIG. 7 is a diagram showing an example of a screen display of an evaluation request sheet page;

FIG. 8 is a diagram showing an example of a screen display of the evaluation request sheet page;

FIG. 9 is a diagram showing an example of a screen display of a detailed condition page;

FIG. 10 is a diagram showing an example of a screen display of the evaluation state page;

FIG. 11 is a diagram showing an example of a screen display of a new evaluation request content page;

FIG. 12 is a diagram showing an example of a screen display of an evaluation answer sheet page;

FIG. 13 is a diagram showing an example of a screen display of the evaluation answer sheet page;

FIG. 14 is a diagram showing an example of a screen display of a detailed condition page;

FIG. 15 is a diagram showing an example of a screen display of an evaluation state page;

FIG. 16 is a diagram showing an example of a screen display of an evaluation state list page;

FIG. 17 is a diagram showing an example of a screen display of an evaluation result input page;

FIG. 18 is a diagram showing an example of a screen display of the evaluation result input page;

FIG. 19 is a diagram showing an example of a screen display of the evaluation state list page;

FIG. 20 is a diagram showing an example of a screen display of the evaluation state page;

FIG. 21 is a diagram showing an example of a screen display of the evaluation state page;

FIG. 22 is a diagram showing an example of a screen display of the evaluation result list page;

FIG. 23 is a diagram showing an example of a screen display of the detailed result page;

FIG. 24 is an explanatory flowchart showing a second embodiment;

FIG. 25 is an explanatory flowchart showing a third embodiment;

FIG. 26 is an explanatory flowchart showing a fourth embodiment;

FIG. 27 is an explanatory flowchart showing a fifth embodiment;

FIG. 28 is an explanatory flowchart showing a sixth embodiment;

FIG. 29 is an explanatory flowchart showing a seventh embodiment;

FIG. 30 is an explanatory diagram showing the seventh embodiment;

FIG. 31 is an explanatory flowchart showing an eighth embodiment;

FIG. 32 is an explanatory flowchart showing a ninth embodiment;

FIG. 33 is an explanatory flowchart showing a tenth embodiment;

FIG. 34 is an explanatory flowchart showing an eleventh embodiment;

FIG. 35 is a diagram showing a construction of system in the twelfth embodiment;

FIG. 36 is an explanatory flowchart showing the twelfth embodiment;

FIG. 37 is a diagram showing an example of a screen display of a Web page of an evaluation component type list; and

FIG. 38 is a diagram showing an example of a screen display of a fee notification screen.

### DESCRIPTION OF THE PREFERRED EMBODIMENTS

Embodiments of the present invention will hereinafter be described with reference to the accompanying drawings. Each of architectures in the embodiments is exemplification, and the present invention is not limited to the architectures in the embodiments.

[First Embodiment]

<System Architecture>

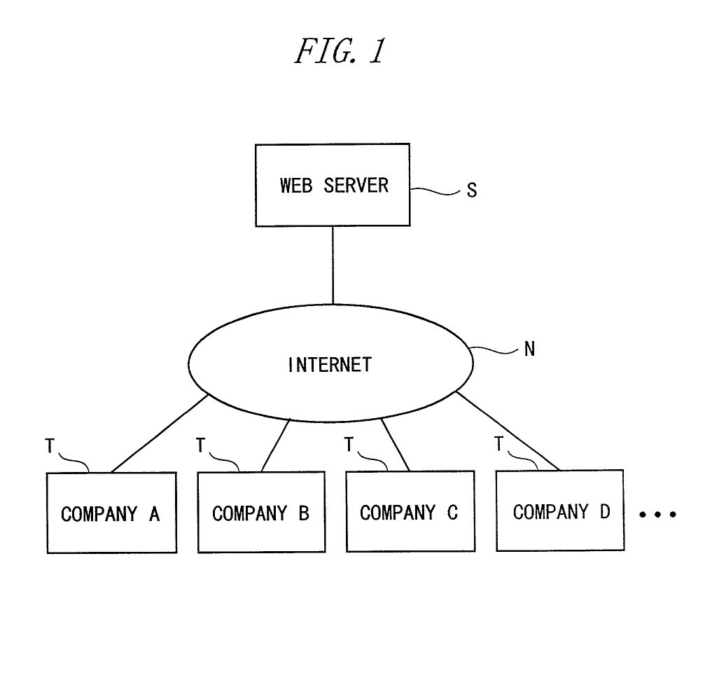

FIG. 1 is a diagram showing a constitution example of a co-evaluation system for a component of an electronic device in the first embodiment. As shown in FIG. 1, this co-evaluation system is configured by a World Wide Web server (WWW server, which will hereinafter simply be called a [Web server]) S for providing home pages (Web sites), a plurality of terminal devices T (FIG. 1 shows four pieces of terminal devices T) each functioning as a WWW client that requests the Web server to provide the homepage, and a network (e.g., Internet) N.

Each of the terminal device T is used by a vendor (a component user) who performs a test for evaluating the component of the electronic device. In the example shown in FIG. 1, the terminal devices T are used respectively by a company A, a company B, a company C and a company D as component users.

The Web server S collects from the component users pieces of information used for co-evaluating the component, and administers and operates a co-evaluation alliance homepage (which will hereinafter simply referred to as a [homepage]) serving as a Web site, on which the respective component users browse the collected pieces of information. The Web server S provides the homepage in response to a Web access from each of the terminal devices T.

The homepage is in principle based on a membership system, wherein only the users who register user's IDs and passwords in the Web server S are allowed to access the principal Web pages. In principle, only the component users capable of evaluating the component voluntarily or in response to a request can register their memberships. The members entrust the administration and operation of the homepage to, e.g., an administration system (administrator).

<Architecture of Web Server>

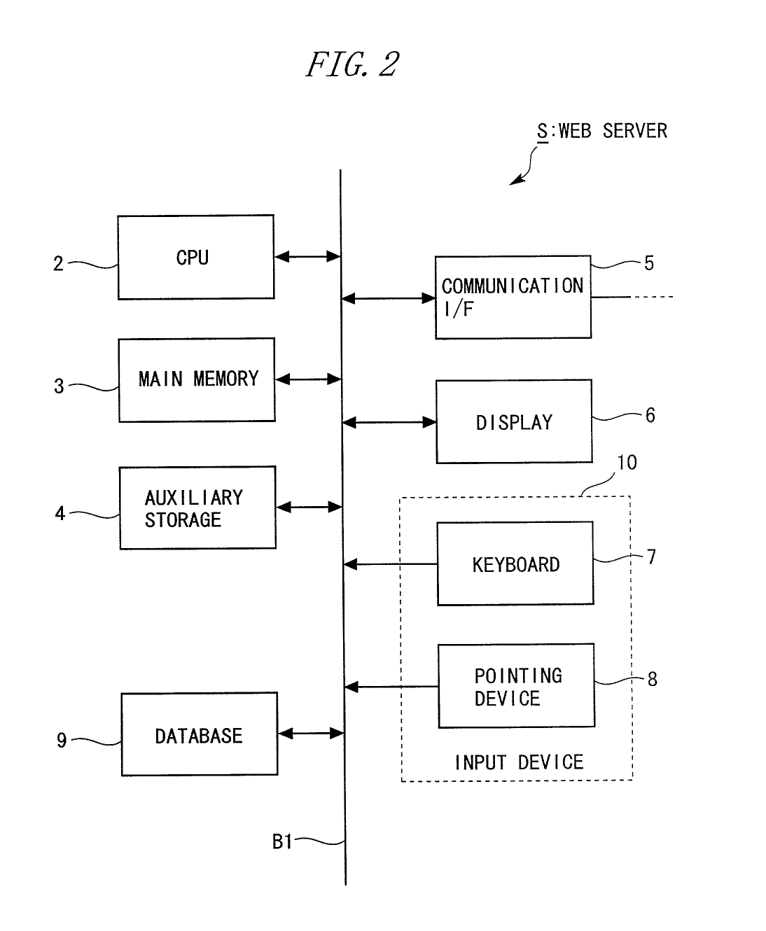

FIG. 2 is a diagram showing an example of an architecture of the Web server S. The Web server S is constructed by use of a personal computer (PC), a workstation (WS), a host computer higher than the PC and the WS, or a server machine for its exclusive use, and so on.

The Web server S includes, a CPU 2, a main memory (MM) 3, a auxiliary storage 4, a communication interface (I/F) 5 connected via a communication line to the internet N, a display (display device) 6, a keyboard 7, a pointing device (PD) 8 and a database (DB) 9, which are connected to each other via a bus B1. The keyboard 7 and the PD 8 will hereinafter be, if generically termed, referred to as an input device 10.

The display 6 involves the use of a cathode ray tube, a liquid crystal display, a plasma display etc. The PD 8 involves the use of a mouse, a trackball, a joystick, a flat point etc. the auxiliary storage 4 is constructed by using a readable/writable recording medium such as a hard disk, a floppy disk, an optical disk, a magneto optical disk (MO), etc.

The auxiliary storage 4 is stored with programs in a plurality of categories executed by the CPU 2, and with data used when executing these programs. The plurality of programs are an operating system (OS), programs related to a communication protocol suite (TCP/IP (Transmission Control Protocol/Internet Protocol, HTTP (HyperText Transfer Protocol, FTP (File Transfer Protocol), SMTP (Simple Mail Transfer Protocol), etc) and a WWW server program suite (HTTP server program, a CGI (Common Gateway Interface) program, etc). Categories of the data are an HTML (HyperText Markup Language) file for creating the homepage (Web site), a text file, an image file, a video file and a sound file. The homepage (Web site) is made up of a plurality of Web pages created based on the HTML files, and the predetermined Web pages are linked by hyperlinks. The DB 9 is stored with the information collected from the terminal devices T and used for co-evaluating the component in predetermined formats such as text data, image data, etc.

The MM 3 is constructed by using a RAM, etc. The MM 3 is used as an operation area for the CPU 2. Further, the MM 3 is used as a video memory (Video RAM) for storing display data such as the Web page, the text, the image etc displayed on the display 6.

The CPU 2 loads the program corresponding to a command and data inputted by using the input device 10 into MM 3, and executes the program. Further, the CPU 2 reads a necessary item of data from the auxiliary storage 4 to the MM 3 and uses the data for executing the program.

The CPU 2 thereby executes, e.g., a process of communications between the Web server S and each of the terminal device T, a process of creating the Web page corresponding to a request from each terminal device T, and a process of accumulating in the DB 9 the information collected from the respective terminal devices T and used for co-evaluating the component.

Note that the Web server S, though constructed by use of one single computer in FIG. 2, may also be actualized by distributed processing of a plurality of computers. For example, the Web server S may be constructed of the HTTP server and an application server.

Moreover, FIG. 2 shows the example of the architecture in which the Web server S includes the DB 9, however, the DB 9 may be included in other computer (e.g., a database server), and the Web server S obtains a necessary item of data from DB by accessing the database server.

(Terminal Device)

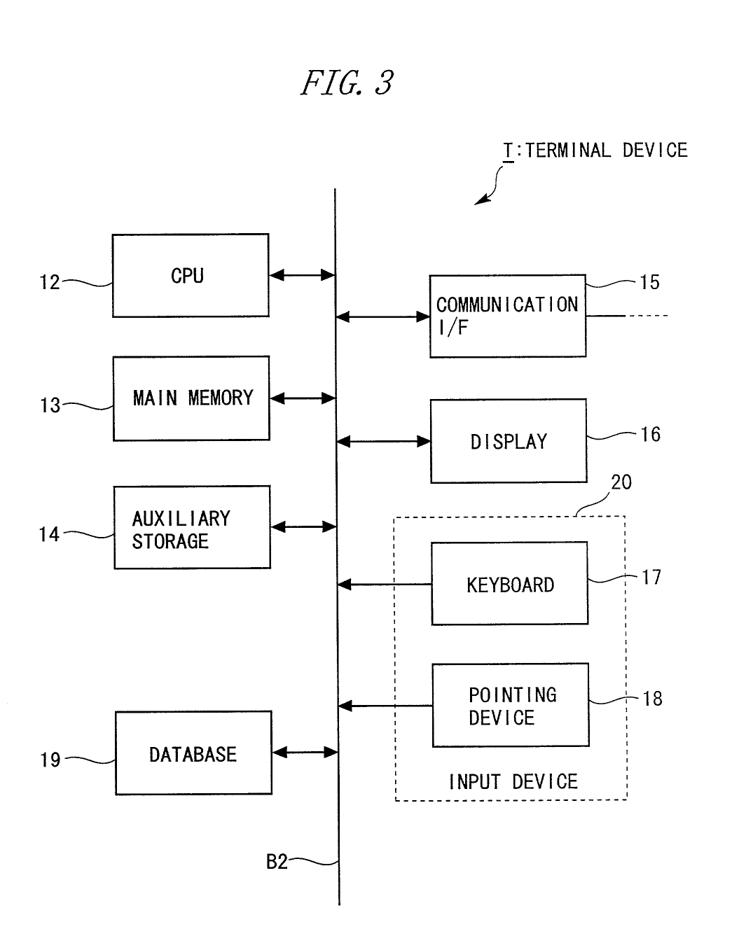

FIG. 3 is a diagram showing an example of an architecture of each of the terminal devices T. The terminal device T is constructed by using the PC. A variety of existing computers usable as a WWW client such as the WS, a mobile computer, a PDA (Personal Digital Assistant), a car navigation terminal etc, can be applied to the terminal device T.

The terminal device T includes a CPU 12, an MM 13, a auxiliary storage 14, a communication interface (I/F) 15 connected via a communication line to the internet N, a display 16, an input device 20 composed of a keyboard 17 and a PD 18, and a DB 19, which are connected to each other via a bus B2.

The auxiliary storage 14 is stored with programs in various categories such as programs (which are, e.g., the Web browser and a program for actualizing the communication protocol that prescribes the communications with the Web server S), and with necessary items of data for actualizing the respective programs.

The CPU 12 loads the program corresponding to a command and data inputted by using the input device 20 into MM 13, and executes the program. Further, the CPU 12 copies a necessary item of data to the MM 13 from the auxiliary storage 14 and uses the data for executing the program.

The CPU 12 thereby executes a process of requesting the Web server S to provide the homepage, a process of displaying the Web page provided from the Web server S on the display 16, and a process of transmitting to the Web server S the data inputted through the Web page.

Note that a mode of connecting each terminal device T to the internet N may include applications of a variety of existing connection modes such as a dialup connection using a telephone line, a connection to ISDN (Integrated Services Digital Network) a connection using a leased line, etc.

<Web System>

Next, a Web system actualized by linking the terminal devices T to the Web server S will be explained. The Web system is a system in which the Web client makes a Web access (HTTP (HyperText Transfer Protocol)) connection to the Web server S in order to access a desired homepage, and thus receives the information displayed on the homepage. Further, in the Web system, the user of the Web client T is also able to input necessary data through the homepage and transmit the inputted data to the Web server S. Atypical operation in a case where the Web server S and the terminal device T function as the Web system, will hereinafter be described.

An operator of the terminal device T, when provided with the homepage from the Web server S, inputs a command of booting the Web browser to the terminal device T by use of the input device 20. Then, the CPU 12 of the terminal device T executes the Web browser stored in the auxiliary storage 14 in accordance with the boot command, then displays an operation screen of the Web browser on the display 16, and connects the terminal device T to the Internet N.

Subsequently, when the operator of the terminal device T specifies an address (URL: Uniform Resource Locator) of a desired homepage by using the input device 20, the CPU 12 transmits a request for providing the homepage containing the URL specified to the Web server S via the communication I/F 15.

When the Web server receives the providing request via the communication I/F 15, the CPU 2 of the Web server S executes the program for the Web server, thereby reading an HTML file corresponding to the URL contained in the received providing request from the auxiliary storage 4 to the MM 3. Alternatively, the CPU 2 creates the HTML file corresponding to the URL. The HTML file created by the above operations is transmitted via the communication I/F 5 to the terminal device T.

The CPU (Web browser) of the terminal device T, when receiving the HTML file, displays the Web page in a predetermined area on the display 16 in accordance with a description of this HTML file. A text described in the HTML file is thereby displayed.

Further, the Web browser obtains from the Web server S an image file and/or a video file related to the HTML file received, and displays an image and/or video based on the image file and/or video file in a predetermined position on the Web page. The operator (user) of the terminal device T can obtain a necessary item of information by browsing the text, the image and the video displayed on the Web page.

Further, the operator is, based on the information displayed on the Web page, able to input the information that should be transmitted to the Web server S by use of the input device 20. The inputted information (input information) is temporarily stored in, e.g., the MM 13. Thereafter, when the operator inputs an indication of transmitting the input information, the CPU 12 transmits the input information temporarily stored in the MM 13 to the Web server S. When the Web server S receives the input information, the CPU 2 stores the received input information in predetermined storage areas provided on the auxiliary storage 4 and on the DB 9.

Further, a button, a text and an image embedded beforehand with hyperlinks are displayed on the Web page. The operator, if desiring to move to a hyperlinked Web page, clicks the button etc hyperlinking to this Web page by use of the PD 18. Then, the CPU 12 sends the request for providing this hyperlinked Web page to the Web server S via the communication I/F 15.

The Web server S, upon receiving the providing request at the communication I/F 5, the CPU 2 similarly creates screen data for this hyperlinked Web page and transmits the screen data to the terminal device T concerned. Thereafter, the same operations and processes as those described above, are executed.

As discussed above, according to the Web system, the Web server S provides the Web page that meets the request given from the terminal device T. The user of the terminal device T is thereby able to receive the desired item of information. On the other hand, the user transmits to the Web server S the input information (that should be, for instance, displayed on the Web page) inputted through the Web page. This enables the input information to be transmitted to a desired destination via the Web server S and to be displayed on the Web page.

In the following discussion on the Web system, there will be omitted the internal processes and communications (which may be conceived as processes related to download) performed in the Web server S and the terminal device T in order for the user to browse the Web page, and the internal processes and the communications (which may be conceived as processes related to upload) executed in the terminal device T and the Web server S in order to store the data inputted through the Web page in the Web server S.

<Operational Example>

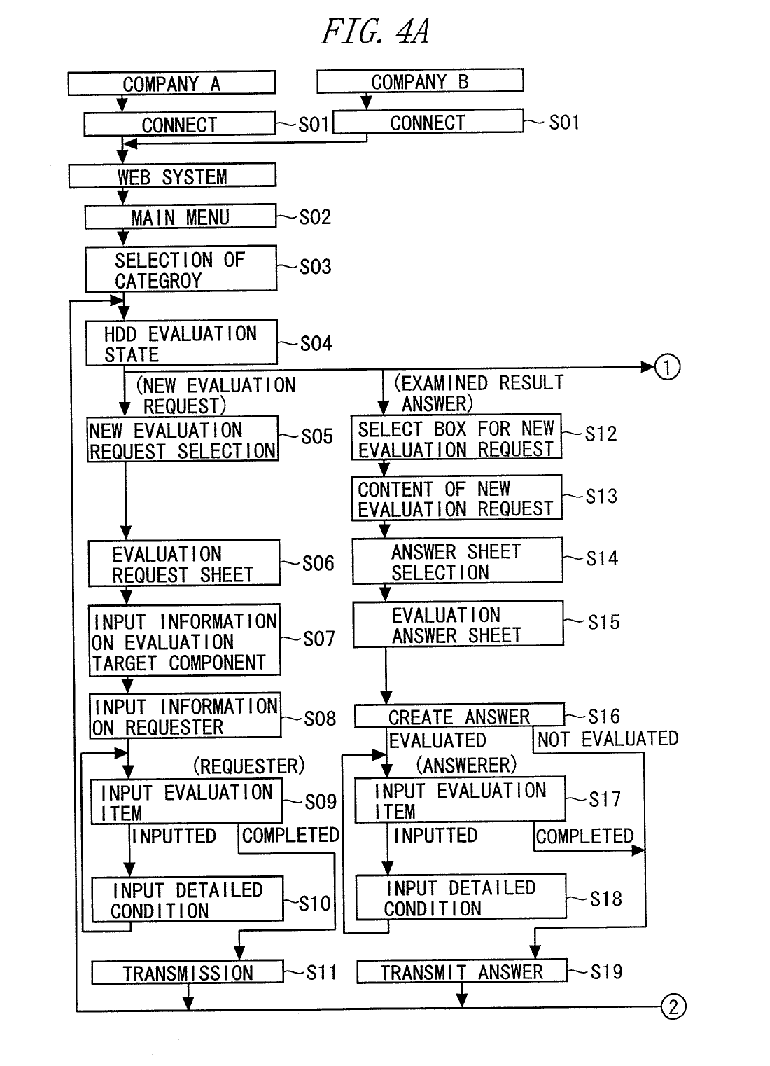

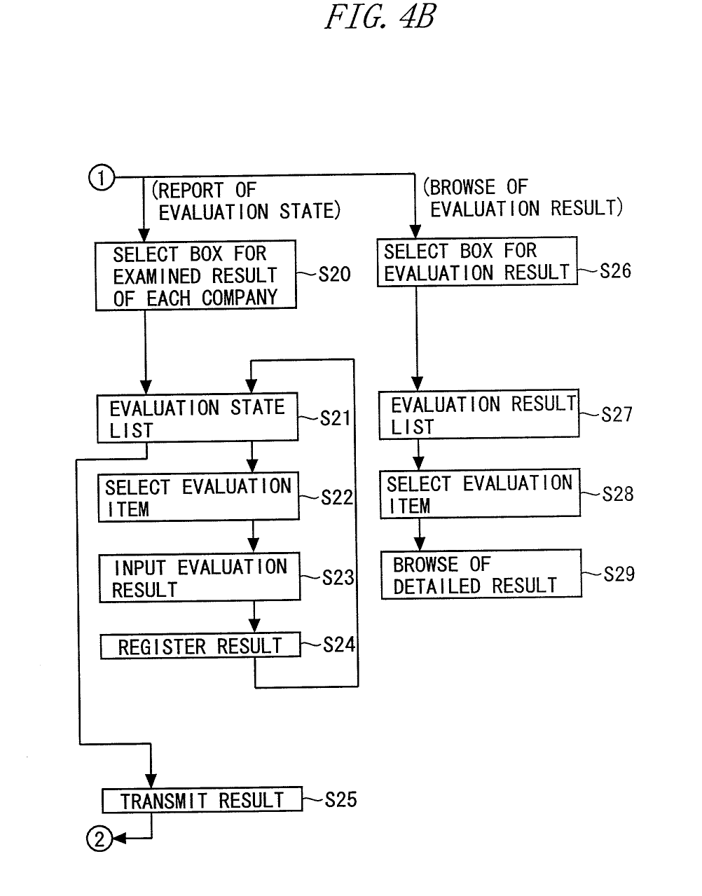

Next, an operational example of the co-evaluation system will be explained. FIGS. 4A and 4B show a flowchart showing a co-evaluation alliance homepage provided by the Web system that actualizes the co-evaluation system. In the following discussion, the operational example is explained in a way that divides the operation into a new co-evaluation request, an answer of examined result, a report of evaluation state and browse of evaluation result.

<New Co-evaluation Request>

Referring to FIGS. 4A and 4B, each of the component users (FIG. 1 shows the companies, A, B, C, D, . . . , and FIGS. 4A and 4B show only the companies A and B) boots the Web browser by operating the terminal device T, and links to (accesses) the homepage provided by the Web server S (step S01).

With this operation, the Web system starts up between the Web server Sand the terminal device T connected to the Web server S. It is hereinafter assumed as an example that (an operator of) the company A as the component user operates the terminal device T.

When the Web system is booted, at first, a category selection page P1 as a top page of the homepage is displayed on the display 16 of the terminal device T (step S02).

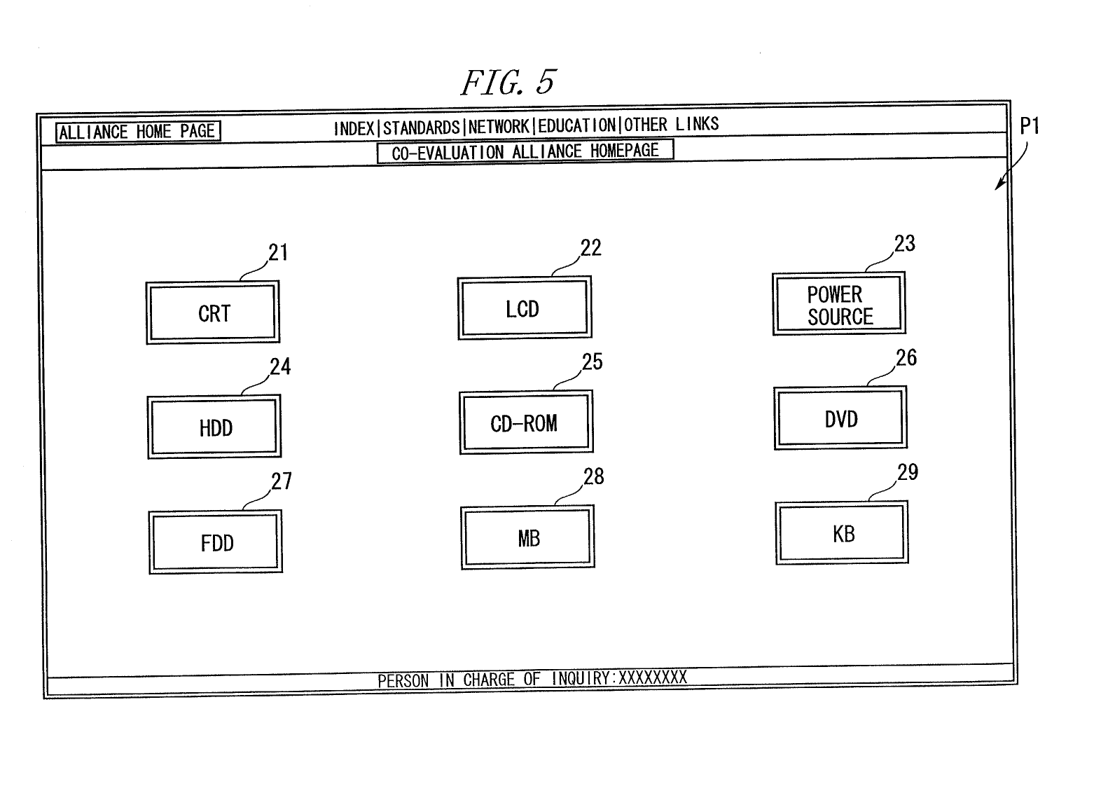

FIG. 5 is a diagram showing an example of a screen display of the category selection page P1. As shown in FIG. 5, the category selection page P1 shows a main menu for selecting a category of the component as an evaluation target. The main menu displays a cathode ray tube (CRT) button 21, a liquid crystal display (LCD) button 22, a power source button 23, a hard disk drive (HDD) button 24, a CD-ROM button 25, a digital versatile (or video) disk (DVD) button 26, and a floppy disk drive (FDD) button 27, an MB button 28 and a KB button 29, which indicate the components of the electronic device.

The company A refers to the category selection page P1 and selects the component category (step S03). To be specific, the company A clicks (presses) any one of the buttons 21˜29 by manipulating an unillustrated cursor displayed on the category selection page P1 by use of the PD 18. The category of the evaluation target component of the company A is thus selected and specified.

When one of the buttons 21˜29 is pressed, an unillustrated user authentication screen is displayed on the display 16. The company A inputs the user name and password registered beforehand in the Web server S to the user authentication screen, and also inputs an indication for transmitting the user name and password.

Then, the user name and password are transmitted to the Web server S from the terminal device T. The CPU 2 of the Web server S judges whether or not the user name and password received by the Web server S are coincident with those of the homepage member registered, thus authenticating the user.

The CPU 2, if the user's authentication is judged to be “OK”, creates screen data of an evaluation state page P2 of the component category specified by clicking the button, and transmits the screen data to the terminal device T. The evaluation state page P2 of the selected component category is displayed replacing the category selection page P1 on the display 16.

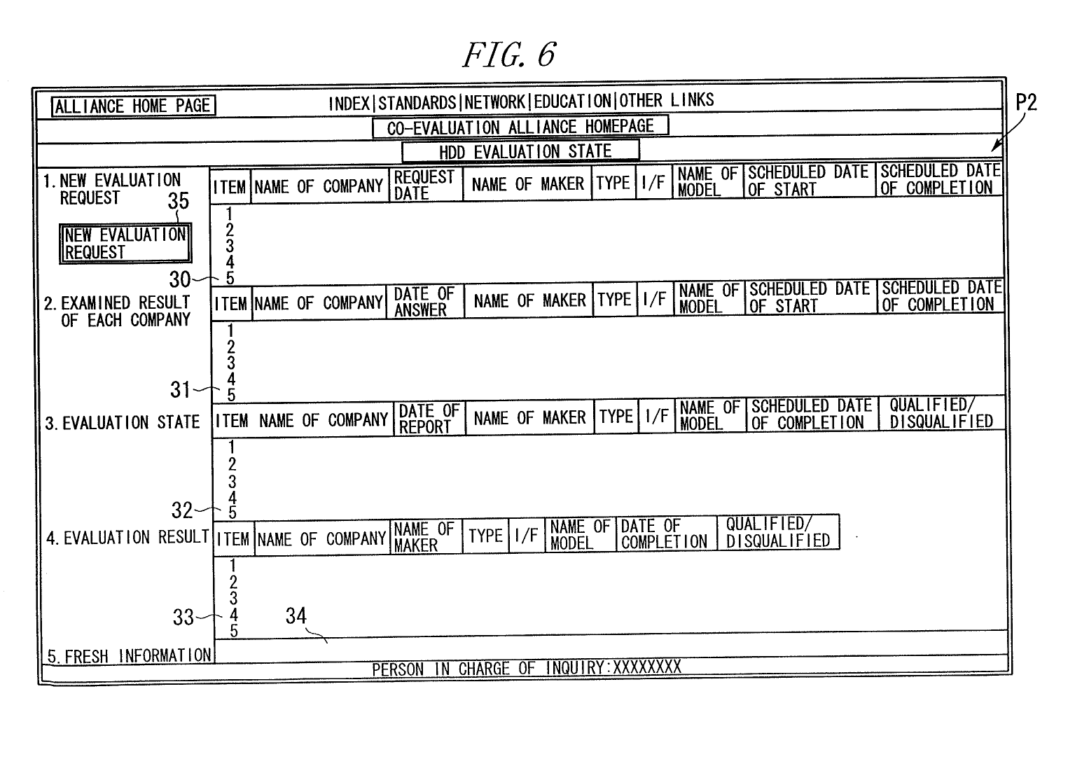

FIG. 6 is a diagram showing an example of a screen display of the evaluation state page P2. FIG. 6 shows the evaluation state page P2 of the HDD as an example displayed in the case of clicking the “HDD” button 24 on the category selection page P1.

The evaluation state page P2 is provided with display boxes 30˜34 for displaying pieces of information on items such as “1. New evaluation request”, “2. Result of examination by company”, “3. Evaluation state”, “4. Evaluation result” and “5. Fresh information”, and also a new evaluation request button 35.

A record as an index showing a outline of the information on each item is displayed in each of the display boxes 30˜33. Further, the information of which the companies should be notified is displayed in the display box 34.

Herein, the company A, if desiring for a co-evaluation with other component user, clicks the new evaluation request button 35. The company A is thereby able to select the new evaluation request (step S05).

Then, an evaluation request sheet page P3 to which the new evaluation request button 35 is hyperlinked, is displayed replacing the evaluation state page P2 on the displayed 16 (step S06).

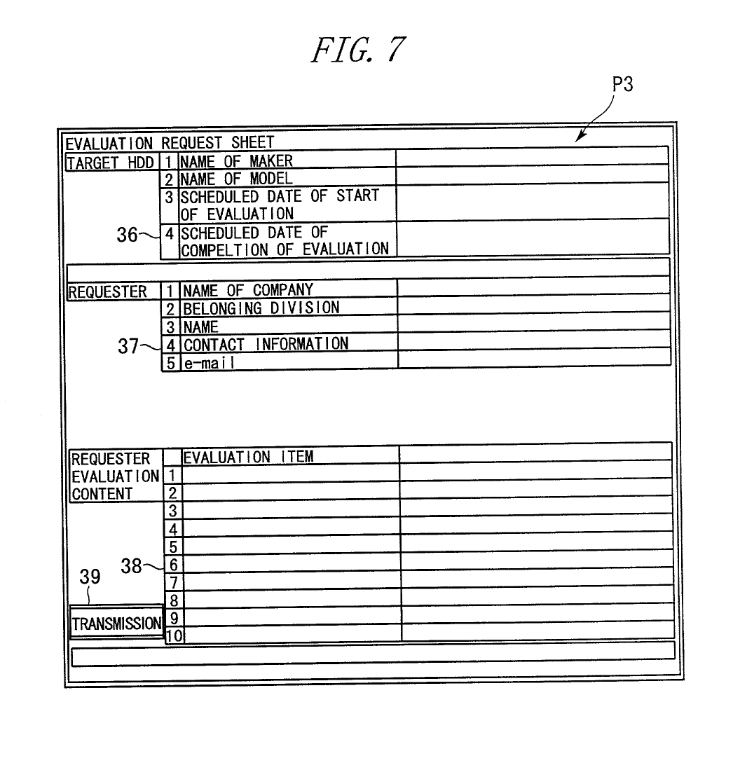

FIG. 7 is a diagram showing an example of a screen display of the evaluation request sheet page P3. The evaluation request sheet page P3 serving as an evaluation request sheet is provided with a plurality of entry boxes 36˜38 for entering pieces of information for requesting the evaluation, and also a transmission button 39.

The company A refers to the evaluation request sheet page P3 and enters necessary items in the entry box 36 (step S07). The entry box 36 is a box for entering specific items of information on the evaluation target component (HDD in this example), a scheduled date of start of evaluation and a scheduled date of completion of evaluation. In this example, a name of maker and a name of model are entered as the specific items of component information.

Next, the company A enters necessary items in the entry box 37 (step S08). The entry box 37 is a box for entering information on a requester (client). In this example, a name of company, a division to which the requester belongs, a name, contact information (e.g., an address and a telephone number) and an E-mail address, are entered as the information on the requester.

Next, the company A enters necessary items in the entry box 38 (step S09). The entry box 38 is a box for entering contents of the evaluation from he requester, i.e., items of the evaluation performed by the company A. the entry box 38 has input sub boxes for entering a plurality of evaluation items (10 items in this example). The input sub boxes of the evaluation items are displayed in a way that allocates their item numbers.

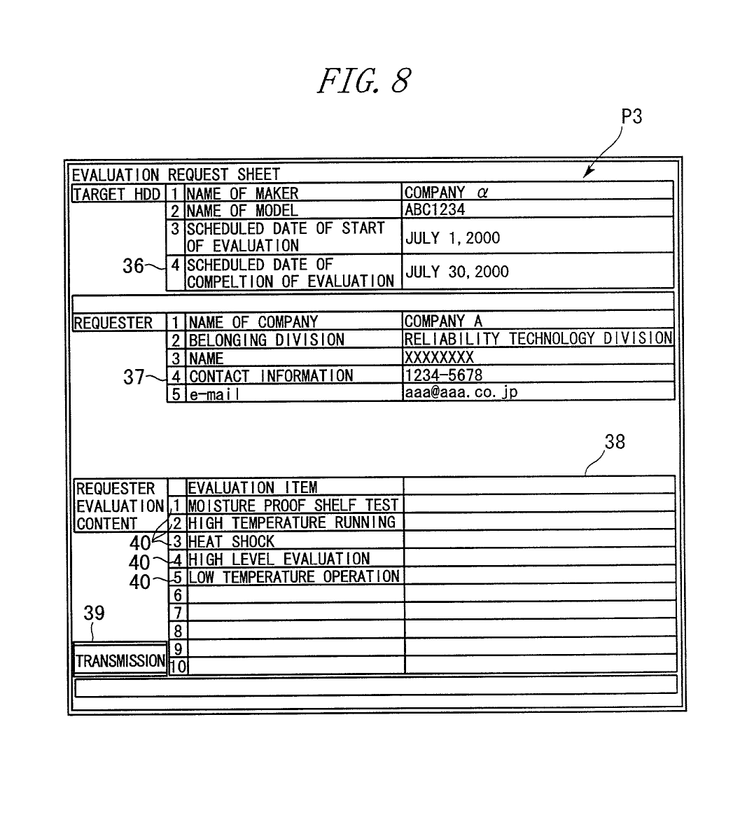

FIG. 8 is a diagram showing the evaluation request sheet page P3 in which the company A enters the necessary items in the entry boxes 36˜38. Referring to FIG. 8, “moisture proof shelf test”, “high-temperature running”, “heat shock”, “high-level evaluation” and “low temperature operation” are entered as evaluation items for the evaluation target component in the entry box 38.

Each of the item numbers allocated to the evaluation items is hyperlinked forwards to a detailed condition page P4 corresponding to the item number. The item number functions as a button 40 for going to the detailed condition page P4.

The company A is capable of selecting and specifying the evaluation item in which a detailed condition should be entered by pressing the button 40 corresponding to the entry box in which the name of the evaluation item is entered. When the company A presses the button 40, the detailed condition page P4 corresponding to the pressed button 40 is displayed replacing the evaluation request sheet page P3 on the display 16.

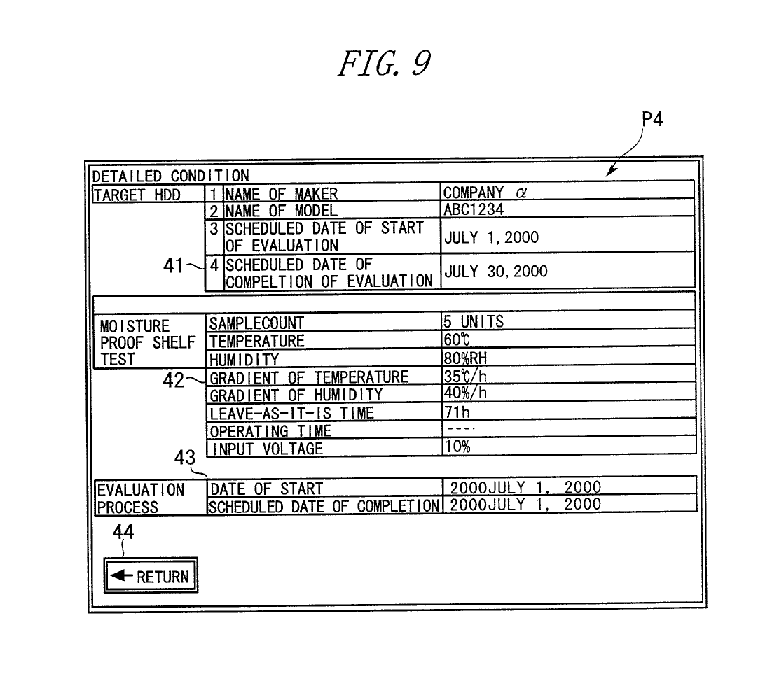

FIG. 9 is a diagram showing a example of a screen display of the detailed condition page P4. The detailed condition page P4 contains a display box 41, entry boxes 42, 43, and a return button 44. The display box 41 is a box for displaying the contents entered in the entry box 37 of the evaluation request sheet page P3.

The entry box 42 has input sub boxes for inputting a plurality of detailed conditions corresponding to the evaluation item selected on the evaluation request sheet page P3. In the example shown in FIG. 9, “sample count”, “temperature”, “humidity”, “temperature gradient”, “humidity gradient”, “leave-as-it-is time”, “operating time” and “input voltage” are given in the input sub boxes as detailed conditions for the evaluation item “moisture proof shelf test”. The entry box 43 is a box for entering an evaluation process and has input sub boxes for inputting an evaluation start date and a scheduled date of completion.

The company A refers to the detailed condition page P4 and inputs detailed conditions set in the evaluation by the company A to the detailed condition input sub boxes of the entry box 42 (step S10). Thereafter, the operator, upon an end of inputting the detailed conditions, presses the return button 44. Then, the evaluation request sheet page P3 (FIG. 8) is displayed replacing the detailed condition page P4 (step S09).

Thereafter, the company A invokes other detailed condition page P4 by pressing the button 40 corresponding to other evaluation items, and inputs detailed conditions corresponding those evaluation items. Then, when finishing inputting the detailed conditions corresponding to all the items of the evaluation carried out by the company A, the company A presses the transmission button 39 (step S11).

The contents (evaluation request contents) entered in the evaluation request sheet page P3 and the detailed condition page P4, are thereby transmitted to the Web server S from the terminal device T. The CPU (FIG. 2) of the Web server S stores the DB 9 with the evaluation request contents transmitted.

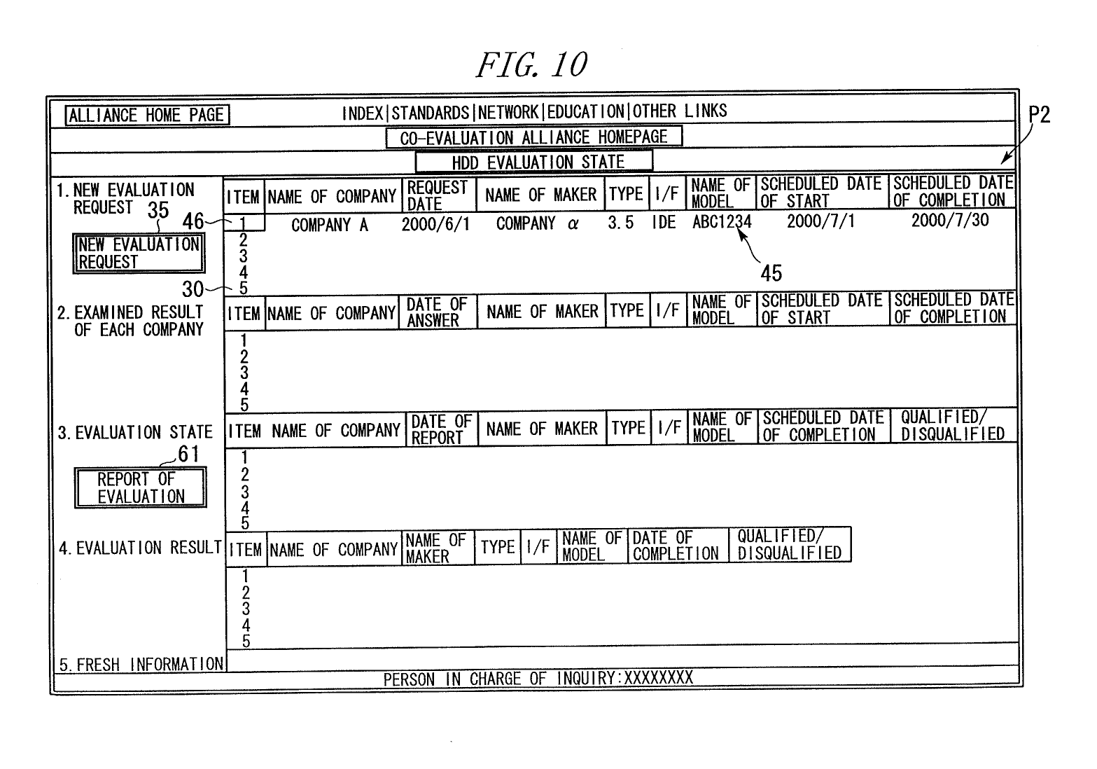

When the evaluation request contents are transmitted to the Web server S by pressing the transmission button 39, the evaluation state page P2 is again displayed replacing the evaluation request sheet page P3 in the display 16 (step S04) At this time, as shown in FIG. 10, a record (evaluation request record) 45 about the evaluation request contents stored in the DB 9 by the processes in steps S05˜S11 described above, is displayed corresponding to a record number (item number) in a display box 30 on the evaluation state page P2.

In the example shown in FIG. 10, the evaluation request record 45 is displayed in the display box 30. The evaluation request record consists of pieces of data such as “company A” in a name-of-company field, “2000/6/1” in a request date field, “company α” in a name-of-maker field, “3.5” in a type field, “IDE” in an I/F field, “ABC1234” in a name-of-model field, “2000/7/1” in an evaluation start scheduled date field, and “2000/7/30” in an evaluation completion scheduled date field.

Thus, the evaluation request record 45 as indexes of the evaluation request contents can be displayed on the evaluation state page P2 by the processes in steps S05˜S11. Thereafter, if other component user (company B etc) accesses the homepage, the evaluation state page P2 containing the evaluation request record 45 is displayed on the display 16. Other component user is able to know the co-evaluation request given from the company A by referring to the evaluation state page P2.

(Answer of Examined Result)

Next, an operational example of an answer of examined result will be explained. A case where after the company A has displayed the evaluation request record 45 on the evaluation state page P2, the operator of other component user (e.g., the company B) accesses the homepage by operating the terminal device T, will be described by way of an example.

Referring to FIGS. 4A and 4B, the company B executes the processes in steps S01˜S04 described above, thereby displaying the evaluation state page P2 on the display 16. Then, as shown in FIG. 10, the evaluation request record 45 put by the company A is displayed on the evaluation state page P2.

The evaluation request record 45 is displayed corresponding to a numeral indicating the record number (item number) allocated to this record 45. The record number (“1” in the example in FIG. 10) displayed functions as a button 46 for browsing details of the evaluation request contents.

Accordingly, the company B, in the case of browsing the details of the evaluation request contents, presses the button 46 by use of the input device 20 (step S12). Then, a new evaluation request content page P5 to which the button 46 is hyperlinked, is displayed on the display 16.

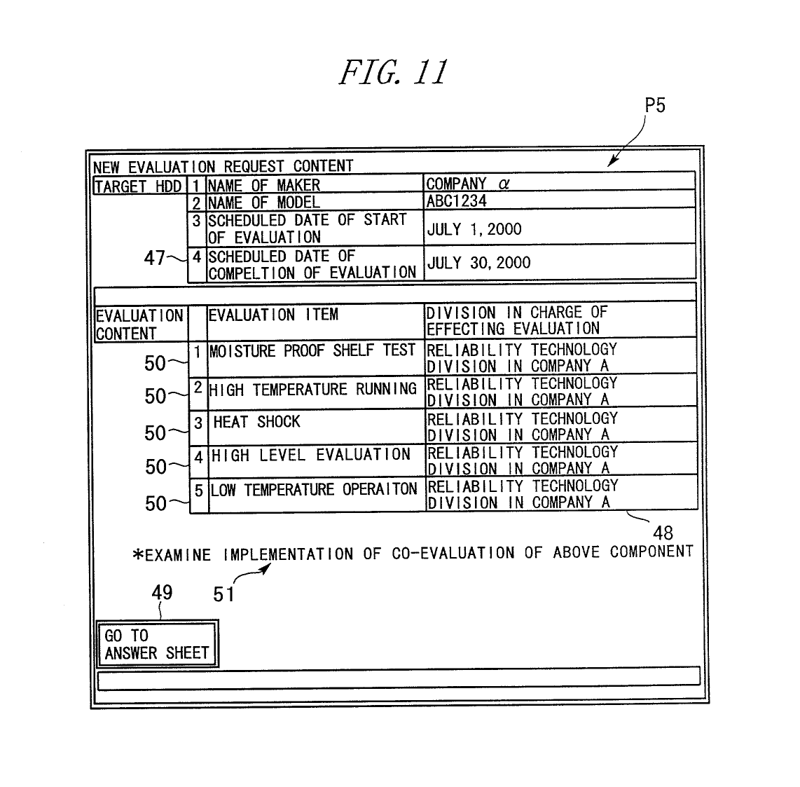

FIG. 11 is a diagram showing an example of a screen display of the new evaluation request content page P5. The new evaluation request content page P5 shows display boxes 47, 48, and a button 49 for going to an answer sheet.

The specific information of the evaluation target component, the scheduled date of start of evaluation and the scheduled date of completion of evaluation that have been entered in the entry box 36 on the evaluation request sheet page P3, are displayed in the display box 47.

The items of evaluation made by the requester (company A) that have been entered in the entry box 38 (FIG. 8) on the evaluation request sheet page P3 and users in charge who implement the evaluations, are displayed in the display box 48.

Further, the display box 48 shows item numbers allocated to the evaluation items, and each item number functions as a button 50 for going to the detailed condition page P4 (FIG. 9) on which to indicate the detailed conditions of the corresponding evaluation item. When pressing the button 50, the detailed condition page P4 to which the evaluation item corresponding to the pressed button 50 is hyperlinked, is displayed on the display 16.

Further, a guide statement 51 [Please, examine whether the co-evaluation of the component is done] is displayed on the new evaluation request content page P5, thus prompting the component users who browse the above pages to examine the co-evaluation.

The company B comprehend request contents of the requester (company A) and contents of the evaluation effected by the requester by browsing the new evaluation request content page P5 and the detailed condition page P4, and examines whether the co-evaluation is done. Thereafter, the company B presses the button 49 (step S14). Then, an evaluation answer sheet page P6 is displayed replacing the new evaluation request content page P5 on the display 16.

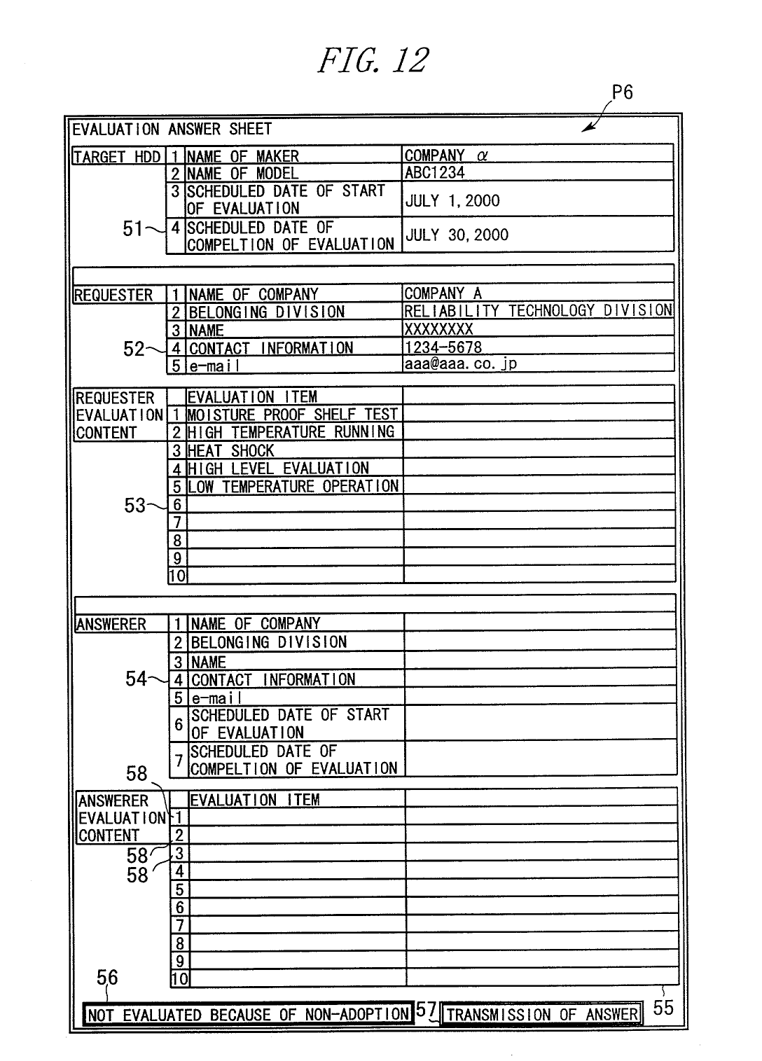

FIG. 12 is a diagram showing an example of a screen display of the evaluation answer sheet page P6. The evaluation answer sheet page P6 contains display boxes 51˜53, entry boxes 54, 55, and buttons 56, 57.

The contents of the evaluation request from the requester that have been entered in the entry boxes 36˜38 on the evaluation request sheet page P3, are displayed in the display boxes 51˜53. The entry box 54 is a box for entering pieces of information on an answerer. In this example, the entry box 54 has input sub boxes for inputting a name of company, a division to which the answerer belongs, a name, contact information (an address, a telephone number etc), an E-mail address, a scheduled date of start of evaluation and a scheduled date of completion of evaluation.

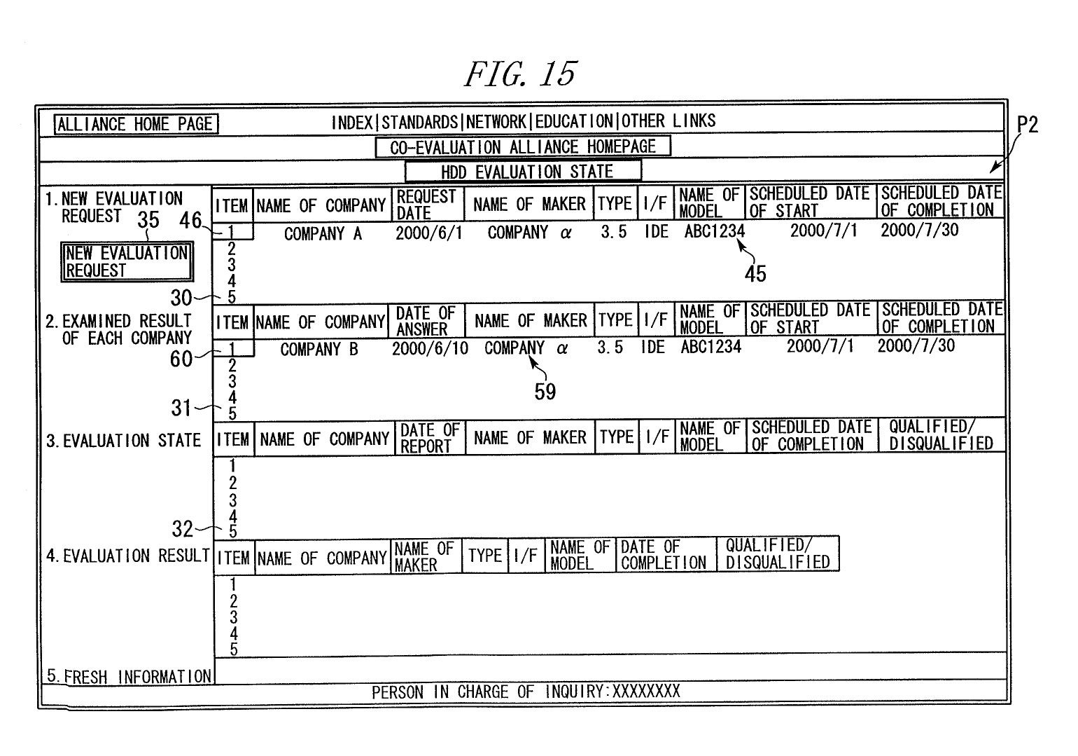

The entry box 55 is a box for entering the contents of evaluation of the answerer, and contains input sub boxes for inputting a plurality of evaluation items. The evaluation item is displayed in each input sub box in a way that allocates the item number thereto. Each item number to which a detailed condition page P7 (see FIG. 15) of a corresponding evaluation item is hyperlinked forwards, functions as a button 58 for going to the page P7.

The button 56 is a button pressed if the co-evaluation with respect to the contents of the evaluation request is not done. The button 57 is a button for transmitting, if the co-evaluation with respect to the contents of the evaluation request is done, the contents entered in the entry boxes 54, 55 to the Web server S.

The company B creates an answer to the evaluation request by use of the evaluation answer sheet page P6 (step S16). Namely, the company B, if not adopting the request as a result of examination by browsing the new evaluation request content page P5, presses the button 56. With this event, the terminal device T notifies the Web server S that the company B does not implement the co-evaluation responding to the request (step S19) (step S19).

By contrast, if the company B evaluates at least one evaluation item in response to the above request (in the case of receiving the request for the co-evaluation), the company B enters necessary items such as a name of company etc in the input sub boxes of the entry box 54, and subsequently enters the item of evaluation performed by the company B in the entry box 55 (step S17). At this time, the company B is capable of referring to the contents displayed in the display boxes 51˜53 as support information for entering the necessary items in the entry boxes 54, 55.

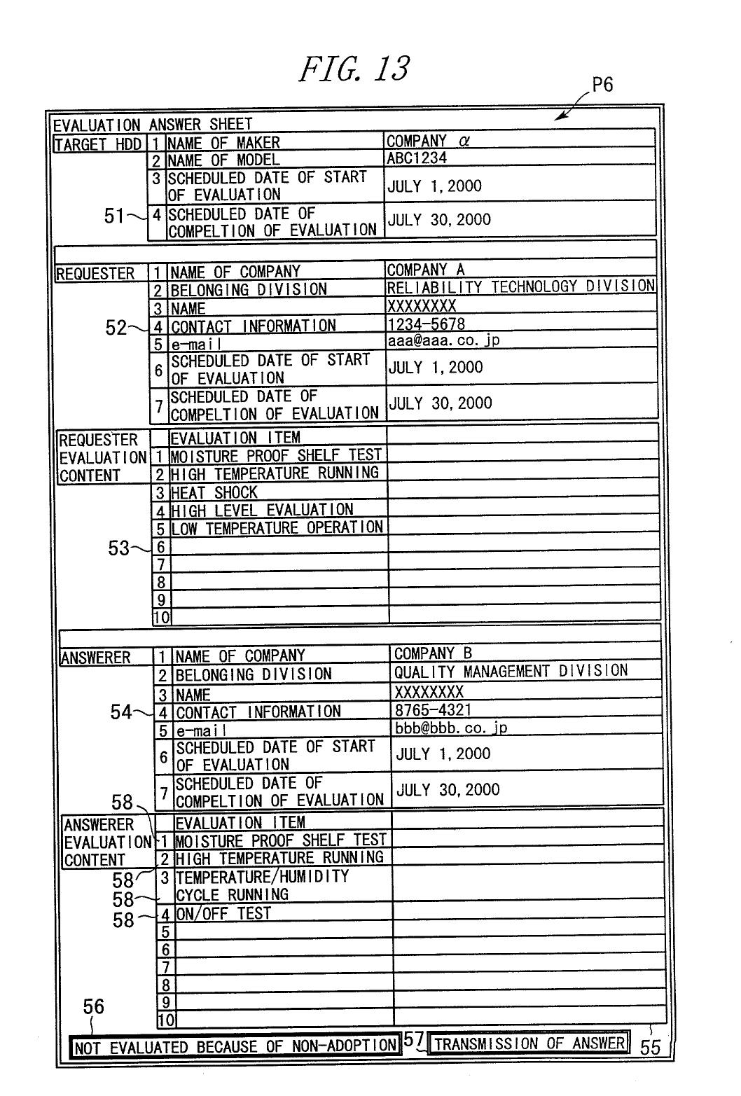

Then, when the company B enters the necessary items in the entry boxes 54, 55, the evaluation answer sheet page P6 comes to, e.g., a state shown in FIG. 13. In the example shown in FIG. 13, there is created an answer that the company B evaluates the evaluation target component (HDD) by performing “moisture proof shelf test”, “high-temperature running”, “temperature/humidity cycle running” and “ON/OFF test”.

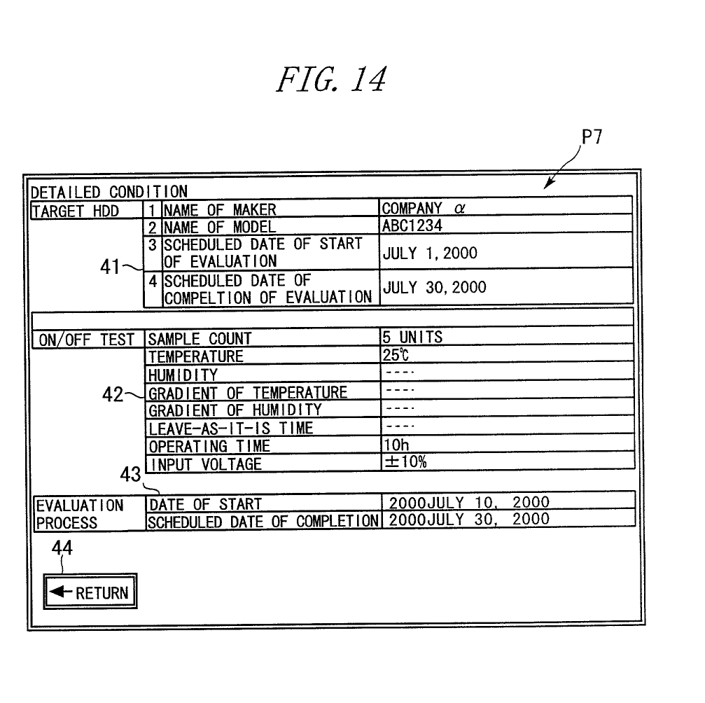

Next, the company B can invoke the detailed condition page P7 corresponding to the evaluation item concerned on the display 16 by pressing the button 58 corresponding to the name of the evaluation item that is entered in the entry box 55. FIG. 14 is a diagram showing an example of a screen display of the detailed condition page P7. The detailed condition page P7 has the same structure as the detailed condition page P4 shown in FIG. 9, and contains display box 41, entry boxes 42, 43 and a return button 44.

The company B refers to the detailed condition page P7, and inputs conditions set for the evaluation carried out by the company B in the input sub boxes, for inputting the detailed conditions, provided in the entry box 42 (step S18). Thereafter, the company B, upon an end of inputting the detailed. Conditions, presses the return button 44. Then, the evaluation answer sheet page P6 (FIG. 13) is displayed replacing the detailed condition page P7 on the display 16 (step S17).

Thereafter, the company B invokes other detailed condition pages by clicking the buttons 58 corresponding to other evaluation items entered in the entry box 55, and inputs detailed conditions corresponding to the evaluation items.

Note that it does not matter whether the items of evaluation performed at the requested component user are coincident with the evaluation items presented by the requester. Further, the detailed conditions set for the common evaluation items may differ between the component users.

If evaluated under the same conditions with respect to the evaluation items common to between the component users, a more appropriate evaluation result (a trouble occurrence rate in the field) can be obtained with a larger number of evaluation target components (a larger sample count). Moreover, if evaluated under a different detailed condition with respect to the common evaluation item, a range of the evaluation for the evaluation item concerned expands, whereby a more appropriate evaluation result can be obtained. Further, if evaluated with respect to the evaluation items that differ between the component users, it is feasible to obtain a more appropriate evaluation result of the component concerned by increasing the number of evaluation items of the evaluation target component.

The company B, upon an end of inputting the detailed conditions for all the evaluation items entered in the entry box 55, clicks a button 57 for sending the answer (step S19). The contents (of the answer) entered on the evaluation answer sheet page P6 and the respective detailed condition pages P7, are thereby transmitted to the Web server S from the terminal device T. The CPU 2 (FIG. 2) of the Web server S stores the transmitted answer contents in the DB 9.

The button 57 has been pressed, and the answer contents have been transmitted to the Web server S, at which time the evaluation state page P2 is again displayed replacing the evaluation answer sheet page P6 on the display 16 (step S04) At this time, as shown in FIG. 15, an answer record 59 and a record number (item number) allocated to this answer record 59 are displayed in a display box 31 of the evaluation state page P2. The answer record 59 is a record relative to the answer contents stored in the DB 9 by the processes in steps S12˜S19 described above. The record number functions as a button 60 hyperlinked forwards to the evaluation answer sheet page P6. In the example shown in FIG. 15, the display box 31 shows the answer record 59 consisting of pieces of data such as “company B” in a name-of-company field, “2000/6/1” in an answer date field, “company α” in a name-of-maker field, “3.5” in a type field, “IDE” in an I/F field, “ABC1234” in a name-of-model field, “2000/7/1” in an evaluation start scheduled date field, and “2000/7/30” in an evaluation completion scheduled date field.

Thus, the answer record 59 as indexes of the answer contents are displayed on the evaluation state page P2 by the processes in steps S12˜S19. Thereafter, when the requester (company A) for the evaluation accesses the homepage, the evaluation state page P2 containing the answer record 59 is displayed on the display 16. The company A can know that the company B participates in the co-evaluation as an answer to the request by referring to the evaluation state page P2.

Further, the company A can browse an evaluation scheme (evaluation items, detailed conditions thereof, a sample count, a scheduled date of start of evaluation and scheduled date of completion of evaluation) that takes place at the company B by repressing a button 60.

(Report of Evaluation State)

Next, an operational example of a report of evaluation state will be explained. A case where the company A puts, on the homepage, evaluation states with respect to the evaluation items displayed on the homepage, will be described by way of an example.

The company A, when reporting the evaluation state, accesses the homepage by the same method as the above, and gets the evaluation state page P2 displayed on the display 16 (steps S01˜S04). Then, the evaluation state page P2 with its contents shown in FIG. 15 is displayed on the display 16.

A record number (item number) allocated to the answer record 59 displayed in the display box 31 functions as a button 60 for going to a page for reporting the evaluation state.

The company A, when reporting the evaluation state, clicks the button 60 allocated to the answer record 59 (step S20). Then, an evaluation state list page P8 is displayed replacing the evaluation state page P2 on the display 16 (step S21).

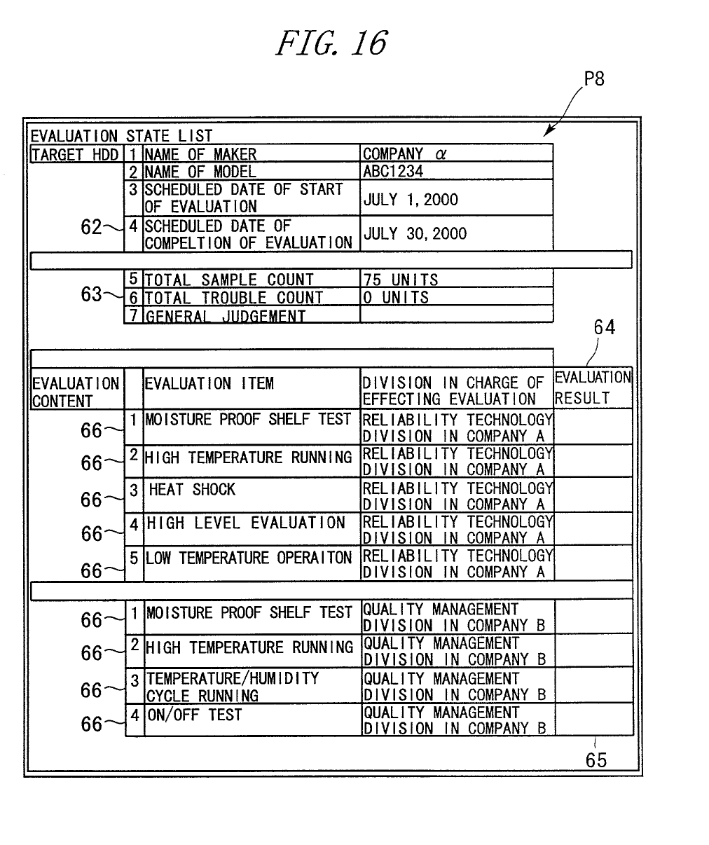

FIG. 16 is a diagram showing an example of a screen display of the evaluation state list page P8. The evaluation state list page P8 has display boxes 62˜65. The display box 62 shows specific pieces of information (a name of maker and a name of model) of the co-evaluation target component, a scheduled date of start of evaluation and a scheduled date of completion of evaluation.

The display box 63 has display sub boxes for displaying the number of co-evaluation target components (a total sample count), the number of samples with troubles occurred (a total trouble count) and a general judgement.

The display boxes 64, 65 are provided for every component user participating in the co-evaluation. In this example, the display boxes 64, 65 corresponding to the companies A and B participating in the co-evaluation, are provided.

The display box 64 displays items of the evaluation performed at the company A, a user in charge of performing each evaluation item, and an evaluation result. On the other hand, the display box 65 displays items of the evaluation performed at the company B, a user in charge of performing each evaluation item, and an evaluation result.

Each of the display boxes 64, 65 is provided with a button 66 corresponding to each evaluation item. The company A selectively presses the button 66 and is thereby able to select the evaluation item of which an evaluation state should be reported (step S22).

Herein, the company A clicks the button 66 corresponding to the evaluation item (e.g., “moisture proof shelf test”) with the evaluation state that should be reported among the plurality of buttons 66 provided in the display box 64. When clicking the button 66, an evaluation result input page P9 corresponding to the button clicked is displayed replacing the evaluation state list page P8 on the display 16.

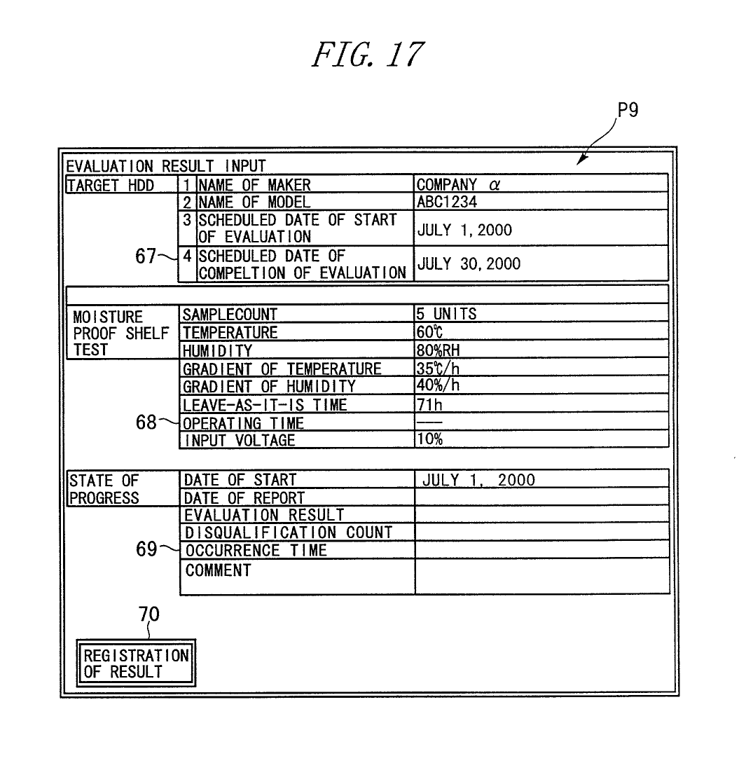

FIG. 17 is a diagram showing an example of a screen display of the evaluation result input page P9. The evaluation result input page P9 includes display boxes 67, 68, an entry box 69, and a result registration button 70.

The display box 67 displays the contents (see FIG. 8) entered by the company A in the entry box 36 on the evaluation request sheet page P3. The display box 68 displays the contents (see FIG. 9) entered by the company A in the entry box 42 on the detailed condition page P4.

The entry box 69 is a box for entering a state of progress of the evaluation for the evaluation item with the evaluation state that should be reported. Therefore, the entry box 69 has input sub boxes for inputting, for instance, a date of start of evaluation, a report date of evaluation state, an evaluation result, the number of samples disqualified (a disqualification count), an occurrence time and a comment.

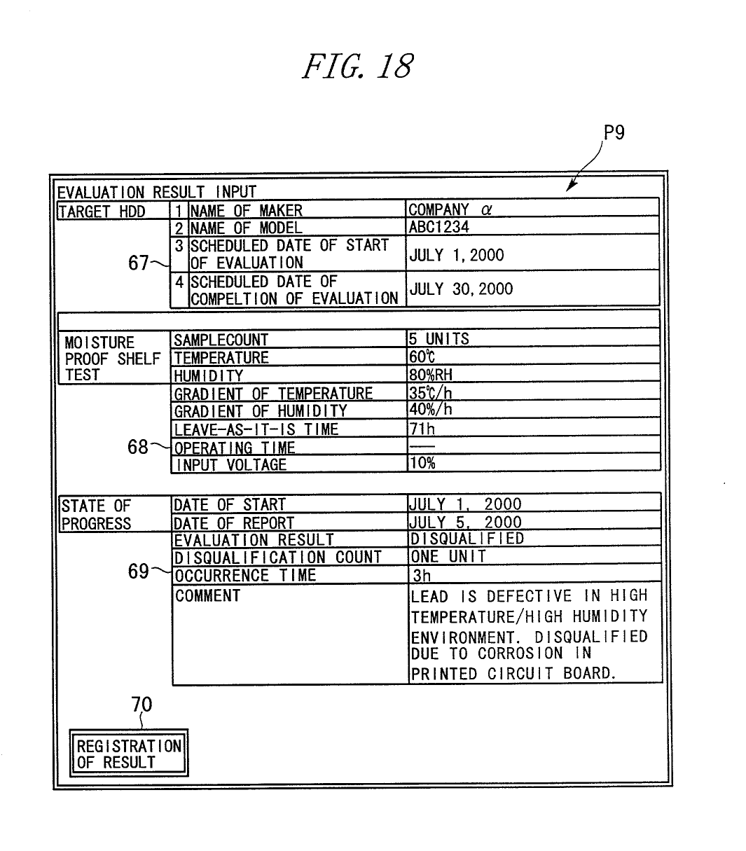

The company A inputs relevant pieces of information to the input sub boxes by using the input device 20 (step S23). With this inputting, the evaluation result input page P9 comes to a state shown in, e.g., FIG. 18. Thereafter, the company A finishes inputting all the necessary items to the entry box 69, an clicks a result registration button 70 (step S24).

Then, the CPU 12 (FIG. 3) of the terminal device T temporarily stores the MM 3 with the items entered in the entry box 69. Further, an evaluation state list page P10 is displayed replacing the evaluation result input page P9 on the display 16 (step S21).

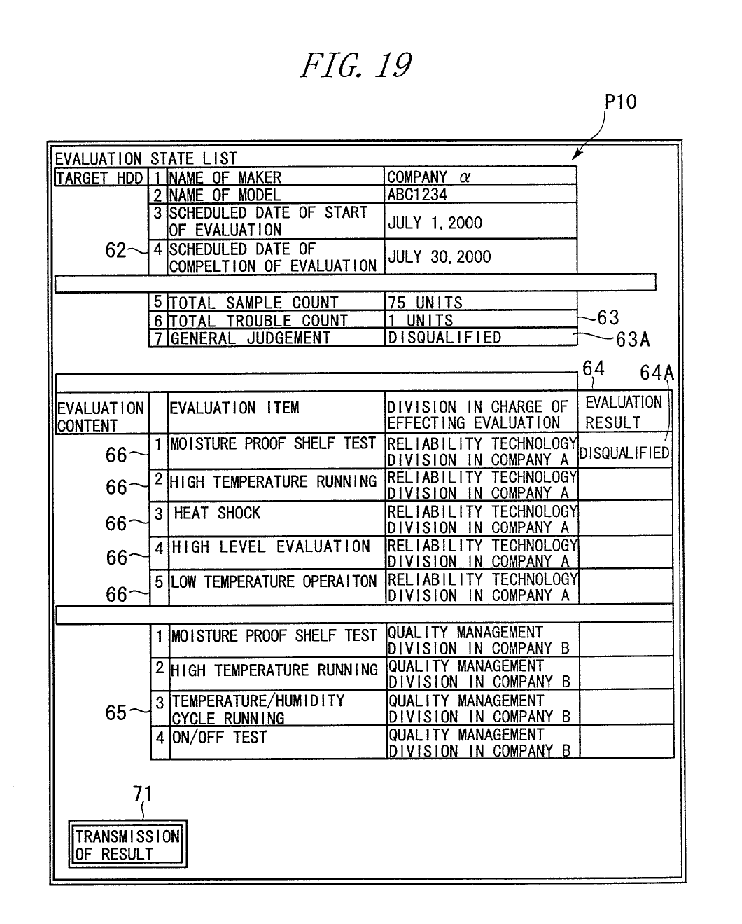

FIG. 19 is a diagram showing an example of a screen display of the evaluation state list page P10. The evaluation state list page P10 has substantially the same structure as the evaluation state list page P8 shown in FIG. 16 except that the page P10 has a result transmission button 71.

The contents inputted on the evaluation result input page P9 are reflected in the evaluation list page P10. Namely, the evaluation results (see FIG. 18) inputted in the entry box 69 on the evaluation result input page P9, are displayed in a display sub box 64A, for displaying the evaluation result of the evaluation item concerned, of the display box 64.

In this example, “disqualified” is displayed in the sub box of the evaluation result on the page P9 as an evaluation result of the evaluation item “moisture proof shelf test” conducted at the company A. “Disqualified” is thereby displayed in the display sub box 64A for displaying the evaluation result of the “moisture proof shelf test” in the display box 64 on the page P10.

The company A, if there are other evaluation items of which the evaluation states should be reported, presses the button corresponding to the evaluation item concerned, and executes the processes in steps S22˜S24. By contrast, when inputting the evaluation results for all the evaluation items with the evaluation states that should be reported, the company A clicks the result transmission button 71 (step S25).

Then, the CPU 12 of the terminal device T transmits to the Web server S a content (which is called an [evaluation state]) entered in the entry box 69 that corresponds to each evaluation item temporarily stored in the MM 3. The CPU 12 of the Web server S stores each of the evaluation states received in the DB 9.

At this time, the CPU 2 makes a general judgement about the evaluation target component on the basis of the evaluation result contained each of the evaluation states received and a predetermined condition preset and stored in the auxiliary storage 4 or the DB 9.

For example, the CPU 2, when receiving the evaluation state for the evaluation item “moisture proof shelf test” from the terminal device T of the company A, detects the evaluation result contained in this evaluation state. Next, the CPU 2 judges whether or not the evaluation result meets the predetermined condition.

For example, the predetermined condition is set such that [if at least one evaluation result shows “disqualified”, the general judgement shall be “disqualified”]. Under this condition, the CPU 2 makes the general judgement as being “disqualified” based on the evaluation result “disqualified” of the “moisture proof shelf test”.

Then, the CPU 2, when making the general judgement as being “disqualified”, thereafter displays the general judgement “disqualified” in the display sub box 63A of the display box 63 on the evaluation state list page P10 provided to each terminal device T. In sharp contrast, the CPU 2, when making the general judgement as being “qualified” based on the at least one evaluation result and the predetermined condition, displays this general judgement “qualified” in the display sub box 63A.

The above general judgement process by the CPU 2 is not, however, executed if incapable of making the general judgement based on only the evaluation state received by the Web server S. For instance, the predetermined condition is that [if the evaluation results of the three or more evaluation items are “disqualified”, the general judgement shall be “disqualified”] and, for this condition, if the number of the evaluation states (evaluation results of the evaluation items) received by the Web server S is less than 3, the CPU 2 does not execute the general judgment process.

It is judged by, for example, the following method whether the general judgement should be made or not. To be specific, when the Web server S receives the evaluation states, the CPU 2 reads from the DB 9 the already-received evaluation results with respect to the component corresponding to the received evaluation states, and judges from the evaluation results contained in the received evaluation states and the readout evaluation results whether the general judgement based on the predetermined condition can be made.

Note that the general judgement process described above may be executed by the CPU 2 if the Web server S receives the evaluation results of all the evaluation items from all the component users who co-evaluate the evaluation target component.

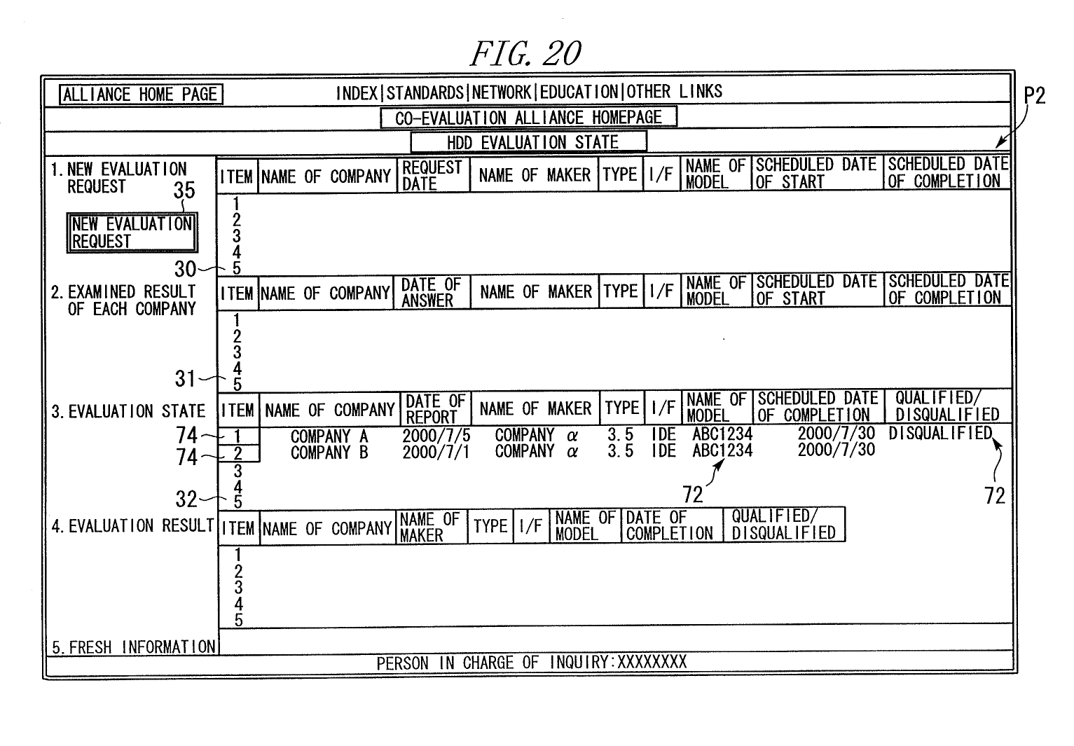

Upon clicking the result transmission button 71, the evaluation state page P2 is again displayed replacing the evaluation result list page P10 (step S04). At this time, an evaluation state record 72 is, as shown in FIG. 20, displayed for every component user in the display box 32 on the evaluation state page P2.

The evaluation state record 72 is displayed when transmitting the evaluation state related to at least one evaluation item to the Web server S. FIG. 20 shows the example of how the data are after each of the companies A and B has transmitted the evaluation state with respect to at least one evaluation item to the Web server S.

The companies A and B refer to the evaluation state page P2 of which the contents are shown in FIG. 20, and are thereby able to comprehend that the co-evaluator reported the evaluation state about at least one evaluation item.

Further, if the CPU 2 of the Web server S has made the general judgement, the general judgement made is displayed in the state of being contained as an element of the evaluation state record 72, and it is therefore feasible to know the general judgement from the evaluation state record 72.

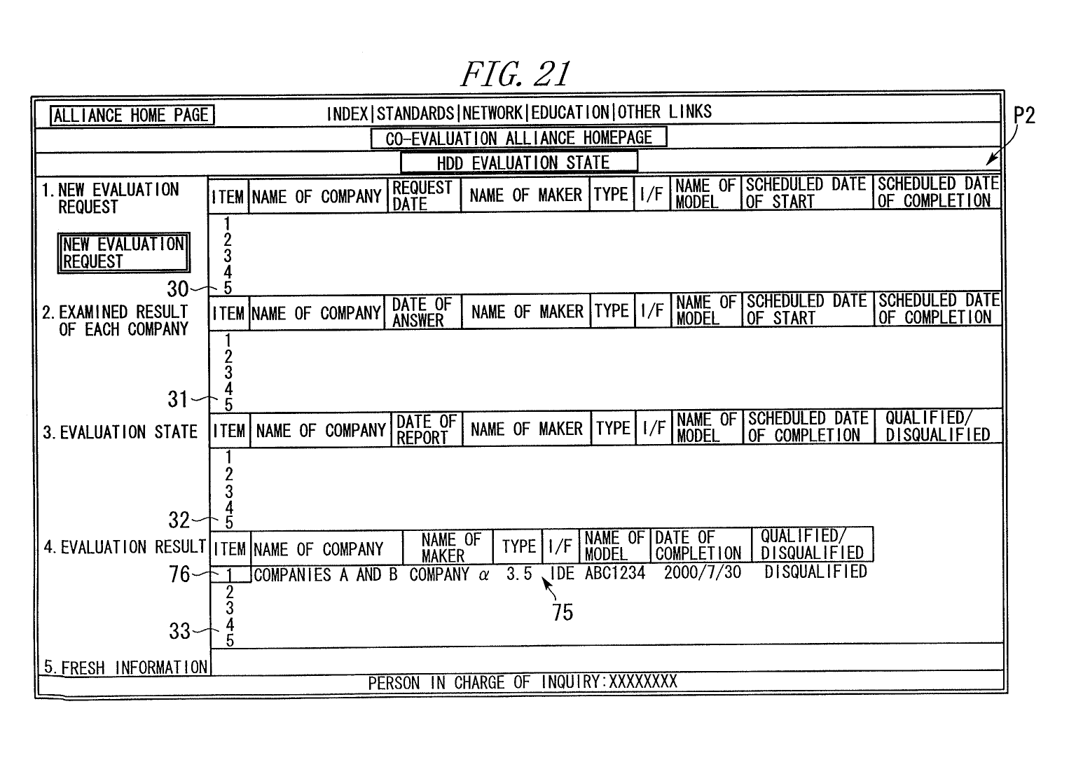

Moreover, each of the companies A and B can invoke the evaluation state list page P10 and the evaluation result input page P9 by clicking the button 74 corresponding to the evaluation state record 72. This enables one co-evaluation to grasp the evaluation state (a progress state of the evaluation) reported by the other co-evaluator. (Browse of Evaluation Result) Next, an operational example of browsing the evaluation result will be explained. The companies A and B finish reporting the evaluation states with respect to all the evaluation items of the evaluation target component by the processes for the new evaluation request, the answer of evaluation result and the report of evaluation state. Thereafter, the companies A and B access the homepage, and, when executing the processes in steps S01˜S04, the evaluation state page P2 shown in FIG. 21 is displayed.

As shown in FIG. 21, after finishing the co-evaluation by the companies A and B, an evaluation result record 75 as an index for the evaluation result is displayed in the display box 33 on the page P2.

The evaluation result record 75 contains, as data elements thereof, a record number, a name of each of component users (names of company) implementing the co-evaluation, a name of maker of the evaluation target component, a type, an I/F, a name of model, a date of end of the co-evaluation and an evaluation result (qualified/disqualified). In the example shown in FIG. 21, “disqualified” is shown as the evaluation result of the co-evaluation.

The record number in the evaluation result record 75 functions as a button 76 for going to an evaluation result list page P11. When a user who browses the homepage clicks a desired button 76 by manipulating the input device 20 (step S26 in FIG. 4B), the evaluation result list page P11 is displayed replacing the evaluation state page P2 on the display 16 (step S27).

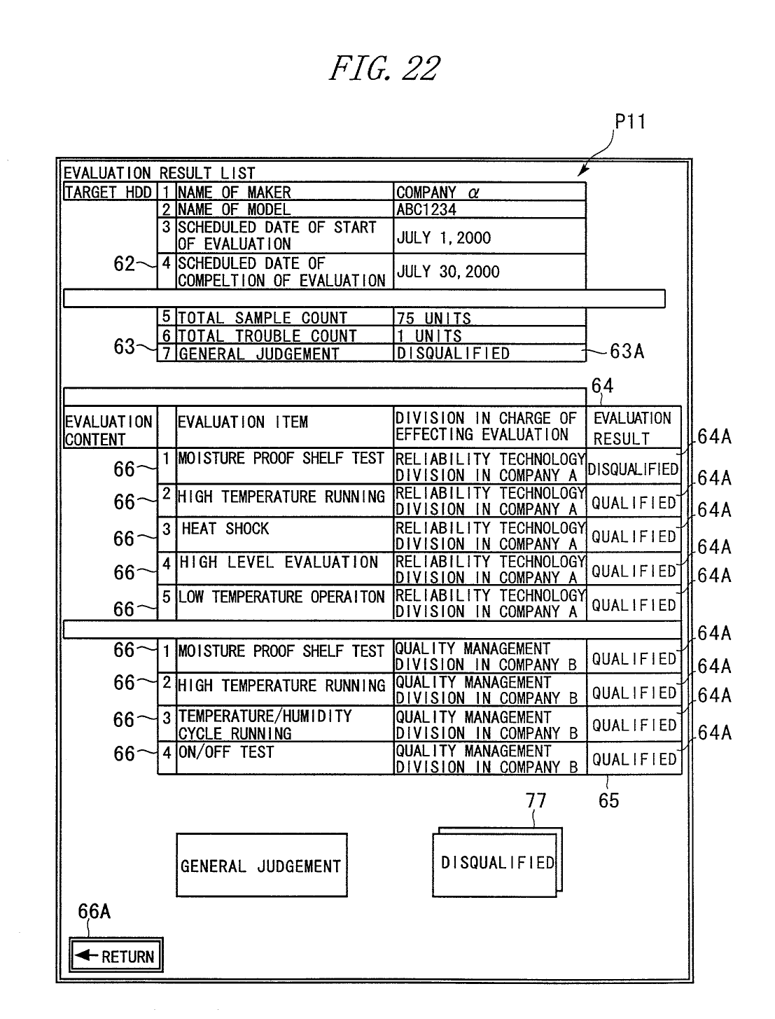

FIG. 22 is a diagram showing an example of a screen display of the evaluation result list page P11. The evaluation result list page P11 displays display boxes 62, 63, 64, 65, a general judgement result box 77 and a return button 66A. The display boxes 62˜65 are the same as the display boxes 62˜65 on the evaluation state list page P10 shown in FIG. 19. Evaluation results with respect to corresponding evaluation items are displayed in the display sub boxes 64A, 65A, for displaying the evaluation results, of the display boxes 64, 65. Further, a general judgement result is displayed in the general judgement display sub box 63A of the display box 63. Moreover, the general judgement box 77 displays the qualification or disqualification of the co-evaluated component.

The browsing user is able to grasp the evaluation result (qualified/disqualified) for the evaluation item and the general judgement result by browsing the evaluation result list page P11. Moreover, the browsing user, when desiring to browse the details of each evaluation item, presses the button 66 corresponding to the desire-for-browse evaluation item among the plurality of buttons 66 provided corresponding to the respective evaluation items (step S28).

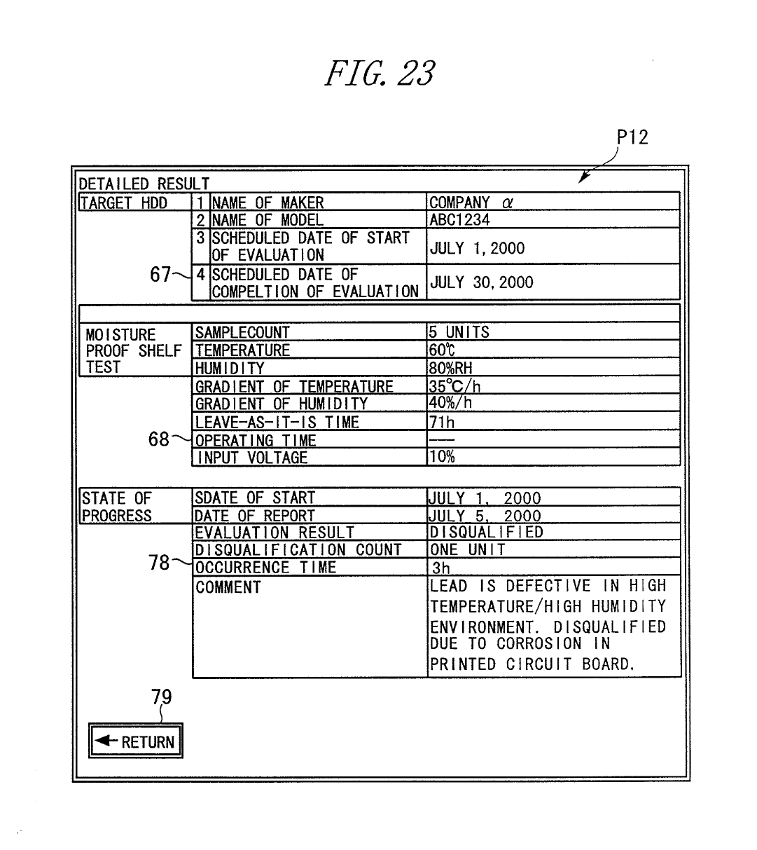

Then, a detailed result page P12 (FIG. 23) is displayed replacing the evaluation result list page P11 on the display 16. While on the other hand, when clicking a return button 66A, the displayed page returns to the evaluation state page P2.

Referring to FIG. 23, the detailed result page P12 has display boxes 67, 68, 78 and a return button 79. The same display contents as the display contents (see FIG. 18) in the display boxes 67, 68 on the evaluation result input page P9, are displayed in the display boxes 67, 68. Further, the same contents as the contents entered in the entry box 69 on the evaluation result input page P11, are displayed in the display box 78.

The browsing user browses the detailed result page P12, thereby making it possible to comprehend the evaluation target component, the evaluation condition and the evaluation result with respect to the evaluation item selected by the browsing user (step S29). Thereafter, when the browsing user clicks the return button 79, the evaluation result list page P11 is again displayed replacing the detailed result page P12 on the display 16.

The browsing user is able to browse the detailed result pages P12 corresponding to other evaluation items by clicking other buttons 66. Thereafter, the browsing user, when finishing the browse of the evaluation result of the co-evaluation, moves back to the evaluation state page P12 shown in FIG. 21 by clicking a return button provided in, for instance, the Web browser.

Note that the operational example given above has dealt with the case where the company A selects the HDD as the evaluation target component, however, each of the pages P2 P12 is prepared for every category of the component displayed on the category selection page P1, and each company may execute the same processes as those described above with respect to the components other than the HDD.

The pages P1˜P12 are provided likewise to the component users accessible to the homepages. Accordingly, in the example given above, other than the companies A and B, the component users (e.g., the companies C and D) not participating in the co-evaluation are capable of, as by the companies A and B, similarly referring to the evaluation states and evaluation results of the co-evaluation described above.

According to the co-evaluation system discussed above, each component user, when evaluating the specified component, executes the processes in steps S05˜S11 in FIG. 4A and is thereby able to display on the homepage the evaluation scheme (at least one evaluation item, the detailed condition (sample count etc) thereof, the scheduled date of start of evaluation, the scheduled date of completion of evaluation etc) conducted at the requester as an evaluation request (new evaluation request).

Other component user can examine whether to participate in the co-evaluation by browsing the new evaluation request displayed on the homepage (steps S12˜S16).

Thereafter, other component user, if participating in the co-evaluation, puts an evaluation scheme carried out by same user on the homepage as a content of answer (steps S17˜S19) The component user as a requester can grasp, as an answer to the request, the evaluation scheme of the evaluation target component, which is implemented by other component user.

Thereafter, each of the component users performing the co-evaluation can display, as an evaluation state, the state of progress of the evaluation with respect to each evaluation item on the homepage (steps S2-˜S25). This enables each of the component users to browse the evaluation states of the evaluations carried out by other component users.

Then, when finishing the evaluations with respect to all the evaluation items in the co-evaluation, each component user having made the co-evaluation accesses the homepage and can browse the evaluation results with respect to the respective evaluation items in the co-evaluation and also a result of the general judgement.

Thus, the respective component users who participated in the co-evaluation, share the evaluation results obtained by the co-evaluation through the homepage. The component users are thereby capable of making use of the evaluation results obtained by the co-evaluation for calculating a trouble occurrence rate in the field of the component concerned.

According to the co-evaluation system, the component users participating in the co-evaluation can exchange and share the information on the co-evaluation with respect to the evaluation target components, the evaluation items, the numerical quantities of the evaluation and the evaluation results with each other through the homepage. The component users can therefore divide the evaluation steps and share the evaluation cost, whereby the component can be evaluated at a higher accuracy of assurance than in such a case that the component user solely evaluates the component.

Further, the component users evaluate the component in cooperation and share the evaluation results, and are therefore able to request the component provider to improve the component in away that takes a collaborative step, so that the component users can take a more solid position with respect to the component provider.

Note that the content of the evaluation request, the content of answer, the evaluation state and the evaluation result are displayed on the homepage, and each component user can obtain the above information by browsing the homepage in the first embodiment discussed above. Instead, the content of the evaluation request, the content of answer, the evaluation state and the evaluation result may also be transferred by an E-mail.

[Second Embodiment]

A system in a second embodiment is configured by adding the following architecture to the co-evaluation system in the first embodiment. To be specific, the Web server S receives the content of the evaluation request or the content of answer from each of the component users participating in the co-evaluation, and thereby receives at least one evaluation item and detailed conditions thereof with respect to the evaluation target component.

The CPU 2 stores the received evaluation item and detailed conditions in the DB 9. At this time, if there exists an evaluation item conducted under the common condition between the component users, the CPU 2 obtains a total number of evaluation target components (sample count) about this evaluation item, and stores this total number in the DB 9.

Thereafter, the CPU 2 waits for the evaluation state to be transmitted from the terminal device T operated by each of the component users participating in the co-evaluation. Then, the CPU 2, if the Web server S receives the evaluation state transmitted from the terminal device T of the component user, stores this evaluation state in the DB 9, and executes the following processes.

Namely, the CPU 2 detects the evaluation result (qualified/disqualified) contained in the evaluation state. At this time, if the DB 9 has already been stored with an evaluation state about other evaluation item, the CPU 2 reads an evaluation result contained in the evaluation state already stored in the DB 9.

Subsequently, the CPU 2 judges whether the detected evaluation result and the evaluation result read from the DB 9 meet a predetermined condition for making a general judgement as being disqualified. The predetermined condition is previously stored in the auxiliary storage 4 or the DB 9 and read by the CPU 2 when making the above judgement.

In the judgement described above, the CPU 2, if the predetermined condition is satisfied, makes the general judgement of “disqualification” about the evaluation target component concerned, and creates an E-mail showing this judgement.

Subsequently, the CPU 2 obtains an E-mail address of each of the component users to which the E-mail should be delivered. The E-mail address is entered in the evaluation request sheet (FIG. 8) and the evaluation answer sheet (FIG. 13). The E-mail as a content of evaluation request or a content of answer is received by the Web server S and stored in the DB 9. Hence, the CPU 2 gets the E-mail by reading it from the DB 9. Then, the CPU 2 delivers the created E-mail addressed to each of the component users participating in the co-evaluation.

As discussed above, the CPU 2 of the Web server S, as for the evaluation state about the specific evaluation item that is transmitted from each component user in the co-evaluation, if capable of making the general judgement of “disqualification” based on the evaluation states received so far and the predetermined condition, creates the E-mail notifying the component users of the general judgement of “disqualification”, and delivers this E-mail to the component users participating the co-evaluation.

With this operation, each of the component users who participated in the co-evaluation can know that the evaluation target component is generally judged to be disqualified as a result of the co-evaluation by receiving the E-mail without browsing the homepage.

With the above architecture added, it is possible to actualize such a function that if, for example, three component users make the co-evaluation, the Web server S monitors a result (evaluation result) of implementing the evaluation made by each of the component users, and, when reaching a level enough to judge the component disqualified as a consequence of integrating the results of the evaluations made by the component users, each of the component users is automatically notified of the result of the disqualification.

Note that the condition for making the general judgement of disqualification may be a condition under which if the plurality of component users evaluate a plurality of samples under the same detailed conditions with respect to a certain evaluation item, and general judgement of disqualification is made when a total number of the samples judged to be defective by the component users exceeds a predetermined threshold value. Note that the predetermined condition may also be a condition for making a general judgement of qualification.

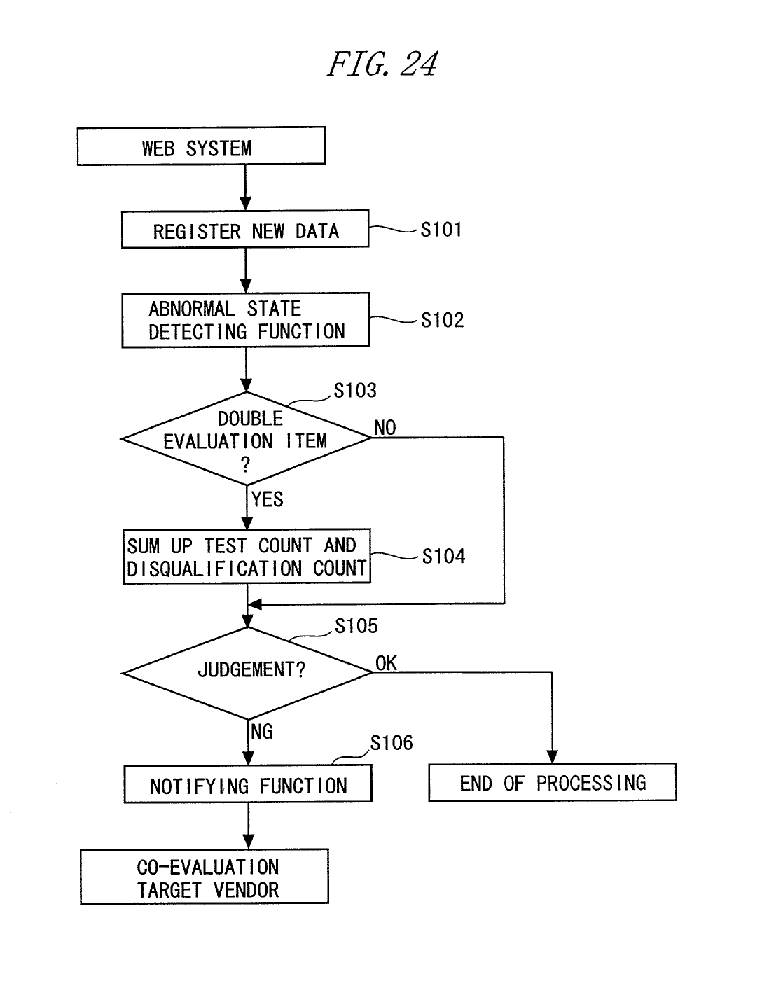

As shown in FIG. 24, if the companies A and B evaluate a certain component by using a predetermined number of samples with the same evaluation items and under the same conditions, pieces of data (evaluation scheme) of this co-evaluation are registered in the DB 9 of the webserver S (step S101). Thereafter, the Web server S is reported of “good” or “defective” with respect to each sample from the companies A and B. The CPU 2 detects a judgement result of “defective” with respect to the sample (abnormal state detecting function: step S102).

Subsequently, the CPU 2 judges whether the evaluation related to the judgement result of “defective” received has the evaluation item carried out dually by the companies A and B (step S103). At this time, if the evaluation has the evaluation item carried out dually, the CPU 2 obtains a total number of samples (test count) subjected to the test performed by the companies A and B with respect to this evaluation item, and also obtains a sum of the samples judged to be “defective” (defect count) respectively by the companies A and B (step S104).

Thereafter, the CPU 2 judges whether the defect counts for the test count is equal to or larger than a predetermined threshold value, thereby judging whether the general judgement shows “NG” (disqualification) or “OK” (qualification) (step S105). If judged to be “NG” (disqualified), the companies A and B are notified of “NG” (disqualification) (step S106).

To give a specific explanation of the processing in FIG. 24, for instance, if two or more defective samples are detected in the process of evaluating a set of 200 samples by each of the three component users (totally 600 pieces of samples are evaluated), a judgement of disqualification is made. In this case, the CPU 2 always monitors the result of the judgement of “defective” and, when a total of the results of the judgements of “defective” comes to 2 or larger, notifies each of the component users of the disqualification.

[Third Embodiment]

According to the co-evaluation system in the first embodiment, each component user displays the content of the evaluation request on the homepage, thereby prompting other component users to participate in the co-evaluation. Instead, a third embodiment has the following architecture.

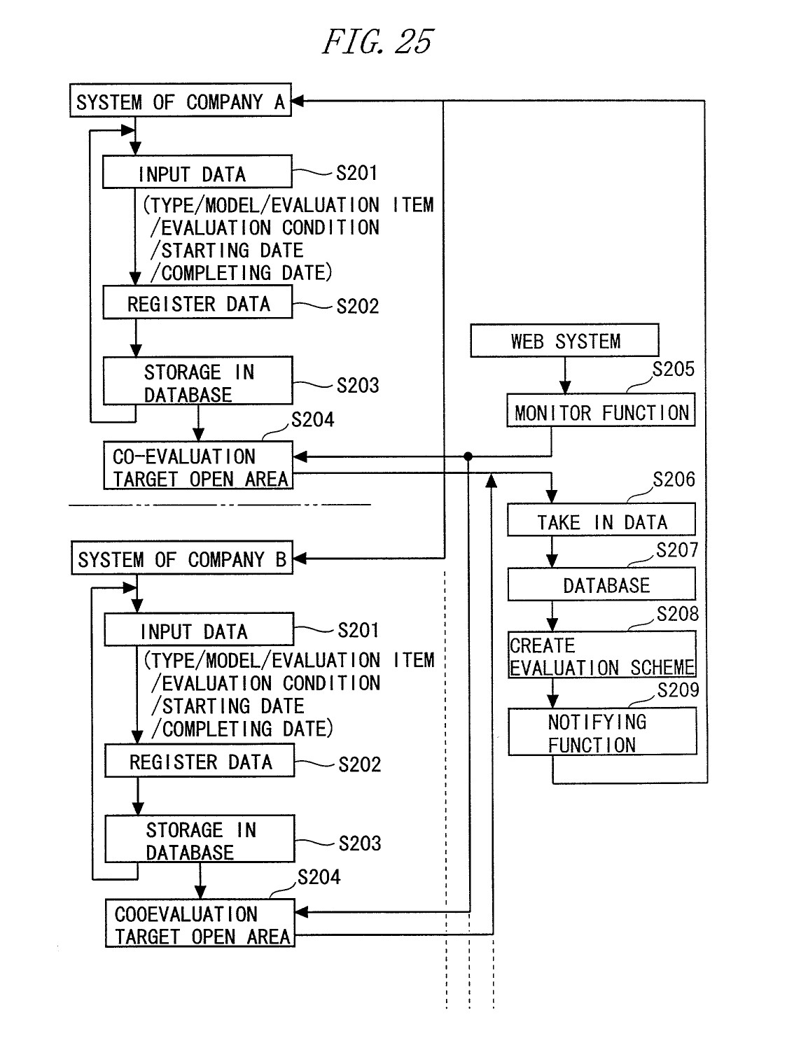

To be specific, as shown in FIG. 25, a DB 19 of the terminal device T operated by each of the component users (the companies A and B in FIG. 23), is used as an evaluation scheme database (evaluation scheme DB).

Each component user inputs to the terminal device T pieces of information (a category and a model of the component, an evaluation item, an evaluation condition, a scheduled date of start of evaluation, scheduled date of completion of evaluation etc) on the evaluation scheme by use of the input device 20 (step S201), and also inputs an indication of data registration (step S202). Then, the CPU 2 accumulates the inputted information on the evaluation scheme in the DB 19 (evaluation scheme DB) (step S203).

At this time, the information on the evaluation scheme is stored in a predetermined area (co-evaluation target open area) within the DB 19 (step S204). This co-evaluation target area is so set as to be accessible from the Web server S.

On the other hand, the Web server S monitors the co-evaluation target area of each terminal device T. This monitoring function can be actualized by the CPU 2 executing a predetermined program for the CPU 2 to implement the monitoring function.

Namely, the CPU 2 accesses the co-evaluation target open area at a predetermined cycle (or in real time) via the Internet N (step S205), and downloads pieces of information on the evaluation scheme which are accumulated in the co-evaluation target open area, into the DB 9 of the Web server S (steps S206, S207).

Subsequently, the CPU 2 creates an evaluation scheme corresponding to a new evaluation request by use of the downloaded information on the evaluation scheme (step S208, and notifies each component user of the thus created evaluation scheme (step S209).

Namely, the CPU 2 puts the evaluation request record 45 (FIG. 10) and the button 46 on the evaluation state page P2 by using the evaluation scheme information downloaded from each terminal device T. Then, the CPU 2 generates pieces of data for generating sets of screen data for the new evaluation request content page P5 (FIG. 11) provided when clicking the button 46, the evaluation answer sheet page P6 (FIG. 12) and the detailed condition page P7 (FIG. 13). The CPU 2 stores those pieces of data in the auxiliary storage 4 or the DB 9.

Thereafter, each component user can invoke the above pages P2 and P5˜P7 on the display 16 by accessing the homepage by operating the terminal device T, thereby making it possible to examine whether to participate in the co-evaluation. According to the third embodiment, each component user may not execute the process of displaying the content of the evaluation request on the homepage (steps S05˜S11).

Note that as a substitute for the architecture described above, in steps S208 and S209, the CPU may create the E-mail containing the evaluation scheme and deliver this mail to other component users. With this architecture also, each component user may not execute the processes (steps S05˜S11) of displaying the content of the evaluation request on the homepage. On the other hand, each of the component users can receive the evaluation request from other component users by receiving the E-mail without browsing the homepage.

[Fourth Embodiment]

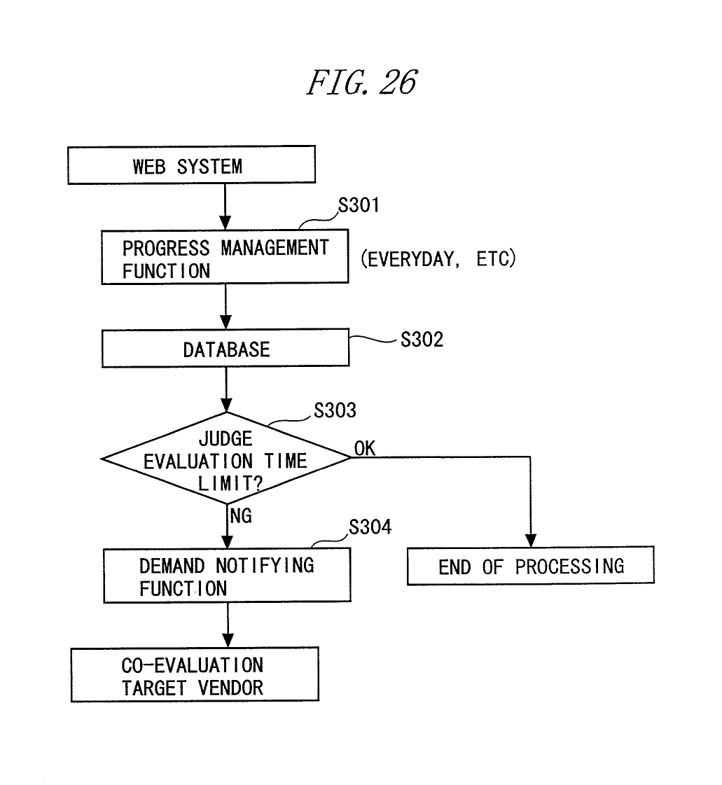

An architecture in a fourth embodiment is what a progress administration function of the co-evaluation is added to the architecture in the first embodiment. FIG. 26 is a flowchart showing the fourth embodiment.

The Web server S, as in the first embodiment, receives the content of evaluation request (the content (FIG. 8) entered in the evaluation request sheet and the detailed conditions) or the content of answer (the content (FIG. 13) entered in the evaluation answer sheet and the detailed conditions) from the terminal device T of each of the component users participating in the co-evaluation. The CPU 2 stores the received content of evaluation request and content of answer in the DB 9.

On the other hand, the terminal device T of each component user as, as in the third embodiment, the DB 19 classified as the evaluation scheme database. Each component user, when having evaluated the co-evaluation target component with respect to the evaluation item that should be carried out, stores the DB 19 with the evaluation state thereof (the progress state (the content entered in the entry box 69: see FIG. 18) entered in the evaluation result input page P9).

The CPU 2 of the Web server S executes a program for actualizing the progress administration function, thereby monitoring a state of how the evaluation state is stored in the DB 19 at a predetermined cycle (e.g., at an interval of one day) Namely, the Web server S accesses the DB 19 of the terminal device T of each of the component users participating in the co-evaluation, and, if a new evaluation state is stored in the DB 19, downloads this evaluation state into the DB 9 of the Web server S (steps S301, S302).

Next, the CPU 2 checks the scheduled date of completion of evaluation with respect to each of the evaluation items performed by the component user that corresponds to the accessed DB 19 by referring to the content of evaluation request and the content of answer which are stored in the DB 19 (step S303).

At this time, if the scheduled data of completion of evaluation with respect to each evaluation item carried out by the component user does not elapse, or, though there elapses the scheduled date of completion of evaluation with respect to a certain evaluation item, if the evaluation state about this evaluation item has already been downloaded into the DB 9 (step S303; OK), the CPU finishes the processing.

By contrast, though the scheduled date of completion of evaluation elapses, if there is an evaluation item of which the evaluation state is not yet downloaded (step S303; G), the CPU 2 creates an E-mail for prompting the terminal device T to store the DB 19 with the evaluation state of this evaluation item, and delivers this mail to the component user (step S304).

According to the fourth embodiment, the component user receives the E-mail and is notified that the user be prompted to implement the evaluation. The E-mail thus can prompt the component user to implement the evaluation. Note that a demand for the evaluation as a substitute for the demanding E-mail may be put on the homepage.

Further, the fourth embodiment has the architecture in which if the scheduled date of completion of evaluation elapses, the E-mail demanding the implementation of the evaluation is delivered. Instead, for instance, if a remaining time up to the scheduled date of completion of evaluation is shorter than a predetermined time, the demanding E-mail may also be delivered.

[Fifth Embodiment]

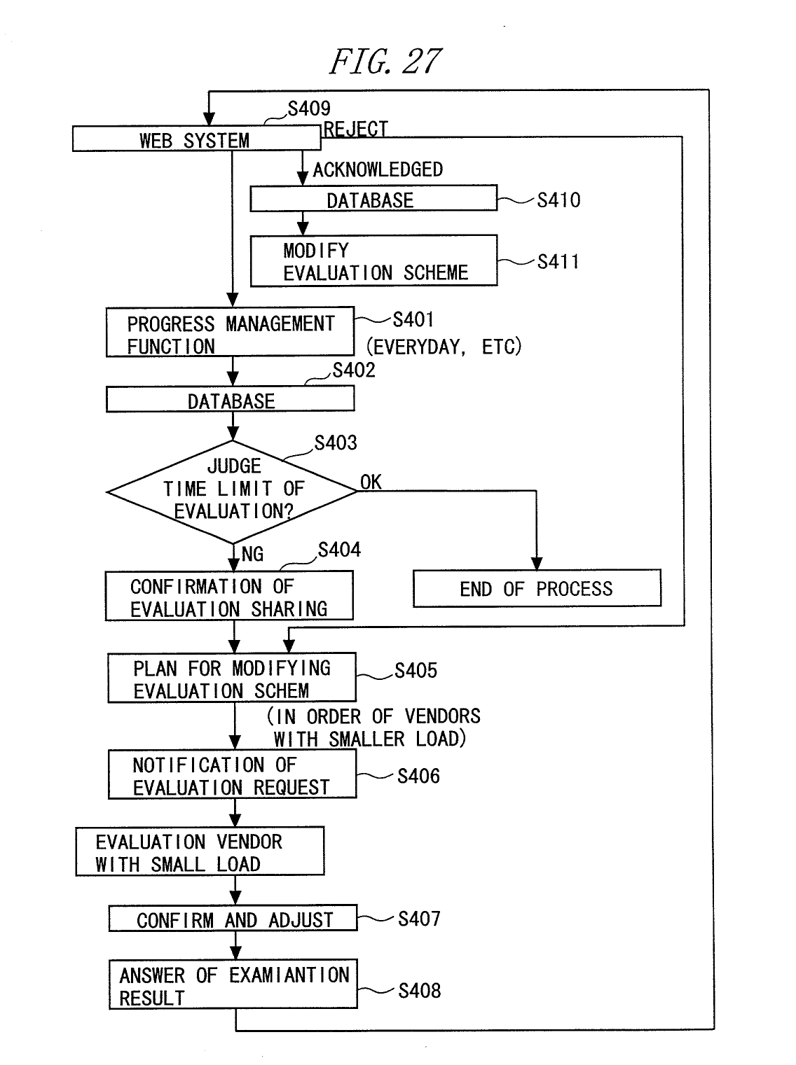

An architecture in a fifth embodiment is what a function of modifying the co-evaluation scheme is added to the architecture in the fourth embodiment. FIG. 27 is an explanatory flowchart showing the fifth embodiment. According to the fifth embodiment, the CPU 2 of the Web server S receives the content of evaluation request or the content of answer from each of the component users participating in the co-evaluation, and stores the DB 9 with the content (the evaluation item and detailed conditions thereof) of the evaluation performed by each of the component users.

At this time, the CPU 2, based on the number of evaluation items carried out by each component user and the number of evaluation target samples, calculates a load rate of the co-evaluation upon each component user. Then, the CPU 2 sets ranks (high rank: large load⇄low rank: small load) corresponding to the load rates in the respective component users. The set ranks are stored in the DB 9.

Thereafter, the same processes (steps S401˜S404) as those in steps S301—S303 explained in the fourth embodiment are executed, thereby judging whether each component user completes the evaluation within the scheduled date of completion of evaluation with respect to each evaluation item.

Then, if there is the evaluation item to which the evaluation related is not finished within the scheduled date of completion of evaluation, in the processes described above, the CPU 2 reads and refers to the ranks of the component users that are stored in the DB 9 and confirms how the component users share (the load rates) the co-evaluation (step S405).

Next, the CPU 2 creates an evaluation scheme modifying plan (e.g., an evaluation request with a time limit of completion of evaluation with respect to the evaluation item to which the evaluation related is delayed) (step S406), and notifies the lowest rank component use by the E-mail (step S407).

The component user receiving the E-mail confirms the evaluation scheme modifying plan contained in the E-mail, and examine whether the user accepts (consents) the evaluation scheme modifying plan (step S407). Then, the component user sends an answer of a result of the examination to the Web server S (step S408).

When the Web server S receives the answer, the CPU 2 judges whether the answer indicates a rejection or a consent of the evaluation scheme modifying plan (step S409). At this time, if the evaluation scheme modifying plan is accepted, the CPU 2 accesses the DB 9 (step S410) and modifies the evaluation scheme with respect to the component user concerned (step S411). Contents displayed on the homepage are thereby changed.

For example, if the implementation of a certain evaluation item is transferred from a certain component user to other component user, this transferred evaluation item is deleted from the evaluation items performed by the former component user, and is added to the evaluation items performed by other component user.

In step S409, whereas if the evaluation scheme modifying plan is rejected, the CPU 2 advances the processing to step S405, and notifies the component user with the second lowest rank of this evaluation scheme modifying plan by the E-mail.

Thus, if the evaluation by any one of the component users is delayed, the CPU 2 of the Web server S creates the evaluation scheme modifying plan, and delivers an E-mail demanding a consent of the evaluation scheme modifying plan to the components users in sequence from the user with the lowest load rate of the evaluation. Then, if the evaluation scheme modifying plan is approved, the co-evaluation launches into a further implementation in accordance with the evaluation scheme modifying plan.

Hence, according to the fifth embodiment, the evaluation scheme is changed and the load rate is modified with no laborious operations of the component users participating in the co-evaluation. Note that if the remaining time up to the scheduled date of completion of evaluation with respect to a certain evaluation item becomes less than the predetermined time, the CPU 2 may create the evaluation scheme modifying plan also in the fifth embodiment.

Moreover, in the architecture in the fifth embodiment, the evaluation scheme modifying plan is transferred by the E-mail. Instead, the evaluation scheme modifying plan and the answer to this plan may also be transferred to the destinations by putting them on the homepage.

[Sixth Embodiment]

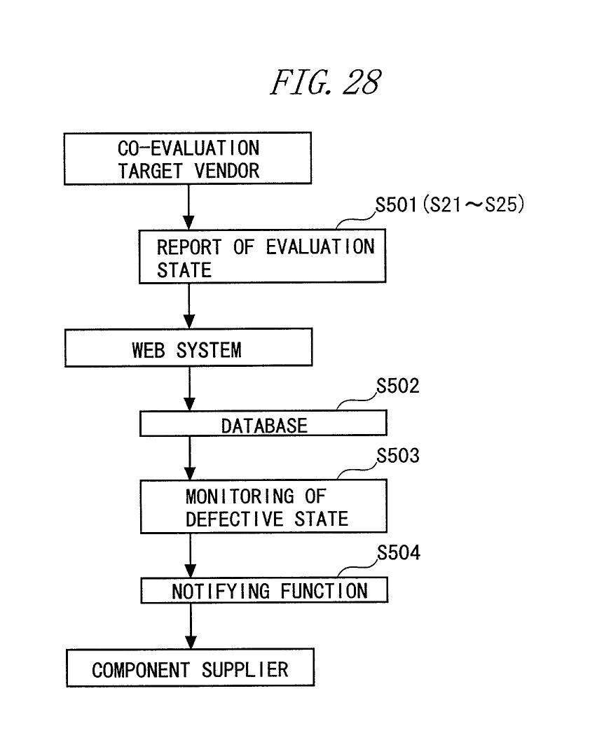

An architecture in a sixth embodiment is what an improvement request notifying function to the component supplier is added to the architecture in the first embodiment. FIG. 28 is an explanatory flowchart showing the sixth embodiment.

As discussed in the first embodiment, the Web server S receives the evaluation state transmitted from each of the component users participating in the co-evaluation. The CPU 2 stores the evaluation state received in the DB 9 (step S502).

Next, the CPU 2 monitors a defective state of the evaluation target component (step S503). For instance, the CPU 2 judges whether the evaluation result contained in the evaluation state stored in the DB 9 in step S502 shows “disqualification”.

If the evaluation result is “disqualification”, the CPU 2 creates an E-mail containing the evaluation item given this evaluation result, the detailed conditions thereof, and a request for improving the evaluation target component, and delivers this E-mail to the supplier of this component (step S504). An E-mail address of the component supplier is, before executing the processes shown in FIG. 27, stored in the auxiliary storage 4 and the DB 9.

The component supplier, upon receiving the E-mail containing the request for the improvement, carries out a necessary process (e.g., a change in design) for improving the component concerned. Thus, according to the fifth embodiment, the component user can notify the component supplier of the request for the improvement in accordance with the evaluation result.

Note that the E-mail containing the improvement request described above, if the CPU 2 makes the general judgement of “disqualification” in the co-evaluation, may be delivered for an improvement of at least one of the evaluation items as factors of the disqualification.

Moreover, another usable setting is that the component supplier can access the homepage by operating one of the terminal devices T, and the improvement request may be displayed on the homepage and transferred to the component supplier through the homepage.

[Seventh Embodiment]

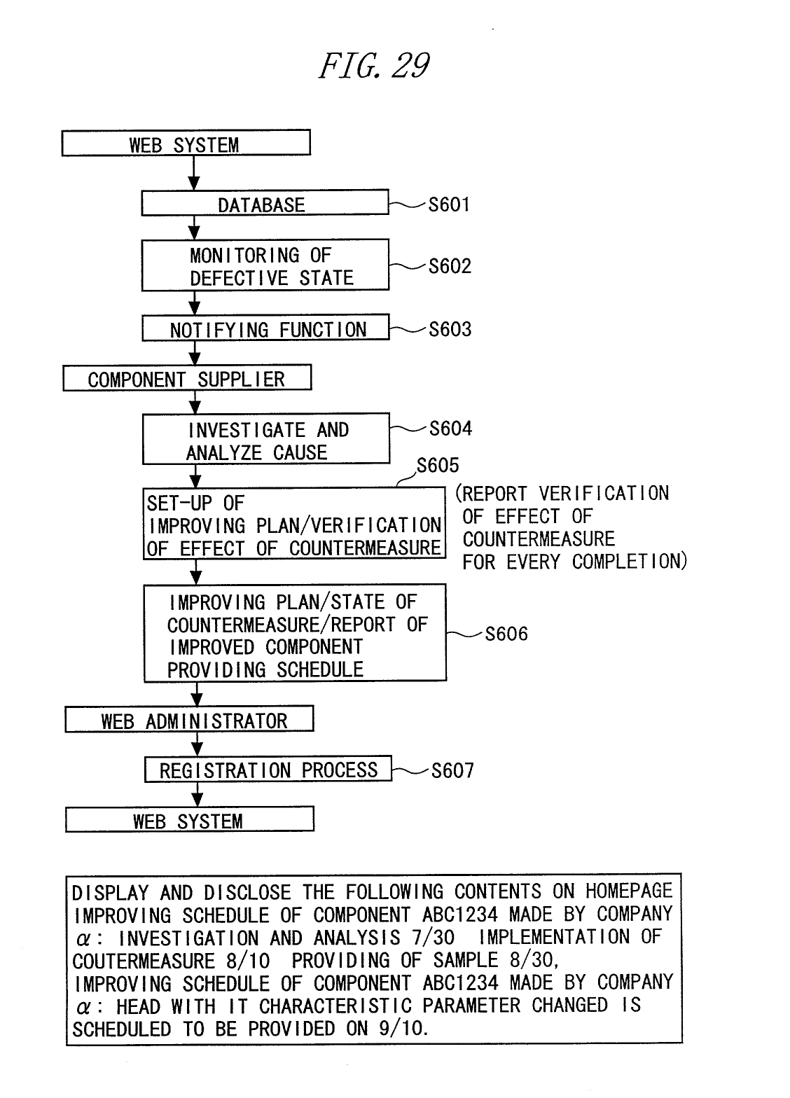

An architecture in a seventh embodiment is what a function of displaying a function of displaying a component improvement schedule made by the component supplier (e.g., the company α) is added to the architecture in the sixth embodiment. FIG. 29 is an explanatory flowchart showing the seventh embodiment.

As shown in FIG. 29, the same processes as those in steps S502˜S504 explained in the sixth embodiment are executed (steps S601˜S603). When the improvement request is transferred to the component supplier, the component supplier investigates and analyzes the cause that the evaluation result of the component concerned becomes “disqualified” (step S604). Next, the component supplier figures out an improvement plan of the component concerned and verifies an effect of countermeasure (step S605).

Thereafter, the component supplier, when report items (e.g., an improvement plan, a state of countermeasure and an improved component providing schedule) to the component users are settled, transfers the report items to an administrator of the homepage (step S606).

The administrator of the homepage inputs the report items to the Web server S by manipulating the input device 10. The CPU 2 registers the inputted report items in the DB 9 (step S607).

Thereafter, the CPU 2, in response to the request for the evaluation state page P2 from the terminal device T, generates the screen data of the evaluation state page P2 containing the report items registered in the DB 9, and provides the terminal device with this set of screen data.

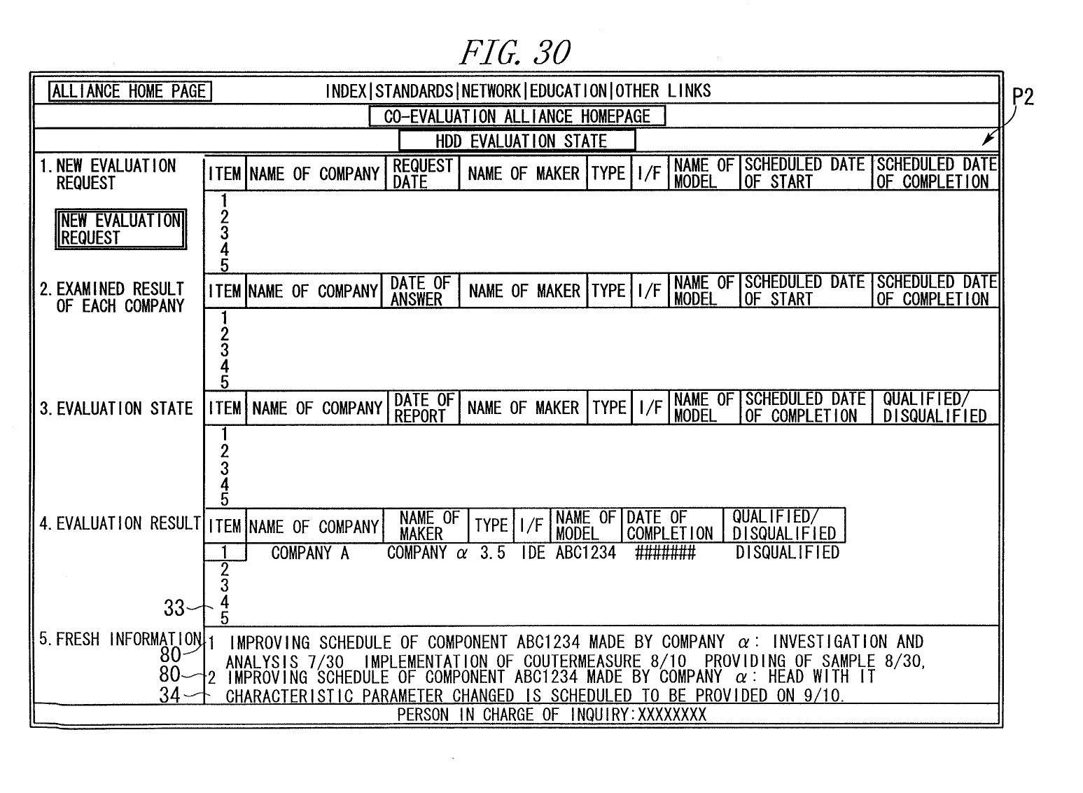

The evaluation state page P2 containing the report items presented from the component supplier is thereby displayed on the display 16 of the terminal device T. FIG. 30 is a diagram showing an example of a screen display of the evaluation state page P2 containing the report items.

As shown in FIG. 30, a report 80 as the report items from the component supplier (the company α) is displayed in a display box 34 on the evaluation state page P2. The report 80 is categorized as, e.g., an improvement schedule of the evaluation target component.

In the example shown in FIG. 30, the display box 34 displays the report 80 such as [the improvement schedule of the component ABC1234 made by the company a: research and analysis will be made on 7/30, a countermeasure will be implemented on 8/10, a sample will be provided on 8/30], and the report 80 such as [the improvement schedule of the component ABC1234 made by the company α: the component with a head's specified parameter changed is scheduled to be provided on 9/10].

According to the seventh embodiment, each of the component users participating in the co-evaluation can receive the improvement schedule relative to the evaluation target component from the component supplier through the evaluation state page P2.

Note that the component supplier transfers the report items to the administrator of the homepage, and the administrator displays the report items on the homepage. Instead of this architecture, the following architecture may also be adopted in the seventh embodiment.

For example, the component supplier, when settling the report items, accesses the homepage by operating the terminal device T and invokes a Web page (unillustrated) for inputting the report items on the display 16. Next, the component supplier enters the report items on the invoked Web page and transmits the report items to the Web server S. the CPU 2 of the Web server S registers the received report items in the DB 9 and uses the report items for generating the screen data for the evaluation state page P2 thereafter.

[Eighth Embodiment]

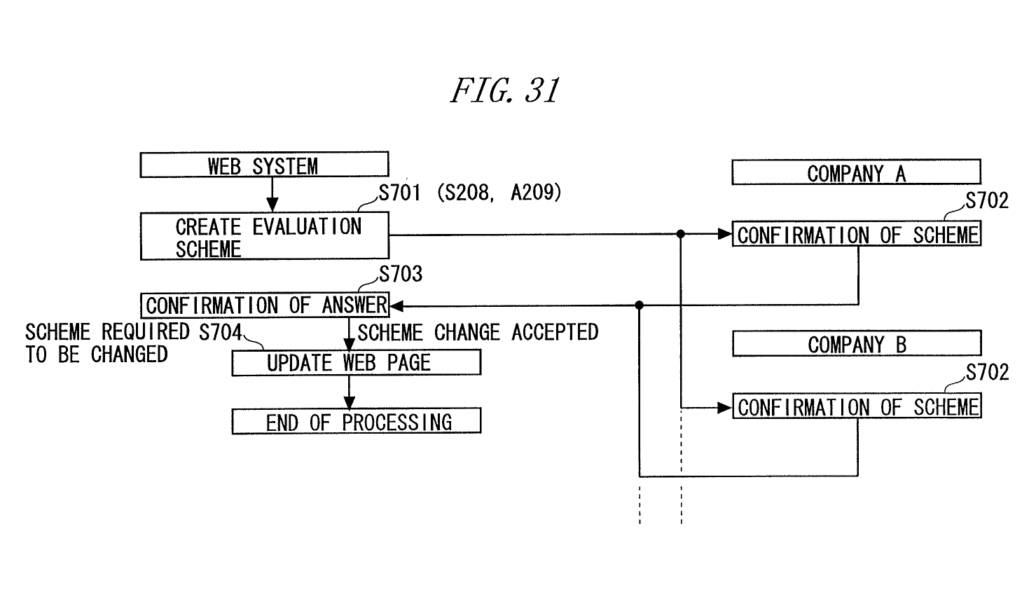

An architecture in an eighth embodiment is what the following configuration is added to the architecture in the third embodiment. FIG. 31 is an explanatory flowchart showing the eighth embodiment. According to the eighth embodiment also, as in the third embodiment, the evaluation scheme is created (step S208 in FIG. 25) and displayed on the homepage (step S701; see step s209 in FIG. 25).

The component users (the companies A and B in the example in FIG. 31) access the homepage by operating the terminal devices T and invoke the pages P5 and P6, thereby confirming the evaluation scheme (new evaluation request) and examining whether to accept the evaluation scheme or to demand a change in this evaluation scheme (step S702).

Each of the component users, if accepting the evaluation scheme, executes the processes in steps S16˜S19 described above (FIG. 4A). In sharp contrast, if demanding the change in the evaluation scheme, the component user invokes on the display 16 an answer Web page (not shown) for inputting an answer to the evaluation scheme. The answer Web page may be a page separate from the pages P5˜P7 and may also be, for example, structured by providing an answer entry box on the page P6.

Each of the component users enters contents of the change request (such as the evaluation item, the detailed conditions, the scheduled date of start of evaluation, the scheduled data of end of evaluation) of the evaluation scheme, in the answer entry box (not shown) provided on the answer Web page. Then, the component user clicks an unillustrated transmission button provided on the answer Web page, thereby transmitting the contents of the change request to the Web server S.

The CPU 2 of the Web server S registers the received contents of the change request in the DB 9. Thereafter, the CPU 2 displays on the homepage the change request contents registered in the DB 9. For example, the CPU 2 displays the change request contents in the display box 34 on the evaluation state page P2.

The component user defined as a requester of the evaluation scheme is able to know that other component users make requests for change with respect to the evaluation made by the component user himself or herself by browsing the evaluation state page P2. This component user examines whether the change requests displayed are acceptable or not (step S702).

Thereafter, the component user invokes the answer Web page corresponding to the change request on the display 16. The answer Web page can be invoked by clicking, for instance, the change request content displayed in the display box 34.

Then, the component user enters on the answer Web page an answer of whether the above change request content is accepted or not and, if not accepted, a revised change request content of this unaccepted change request content, and transmits these pieces of information to the Web server S.

The CPU 2 of the Web server S, upon receiving the answer of the change request that has been transmitted from the terminal device T, judges whether this answer approves the change request content (step S703). At this time, if the answer contains an approval of the change request content, the contents of the relevant pages P5˜P7 are updated based on the approved change request content (step s704).

Whereas if the answer shows that the change request content is not approved, the CPU 2 displays the revised change request content contained in the answer on the homepage (e.g., in the display box 34 on the evaluation state page P2). Thereafter, the processes in steps S702 and S703 are repeatedly executed till the Web server S receives a consent of the revised request content.

According to the eighth embodiment, each component user can make the request for the change in the evaluation scheme presented through the homepage. Then, if the component users performing the co-evaluation accept the change request, the evaluation scheme is changed based on the accepted content of the change.

[Ninth Embodiment]

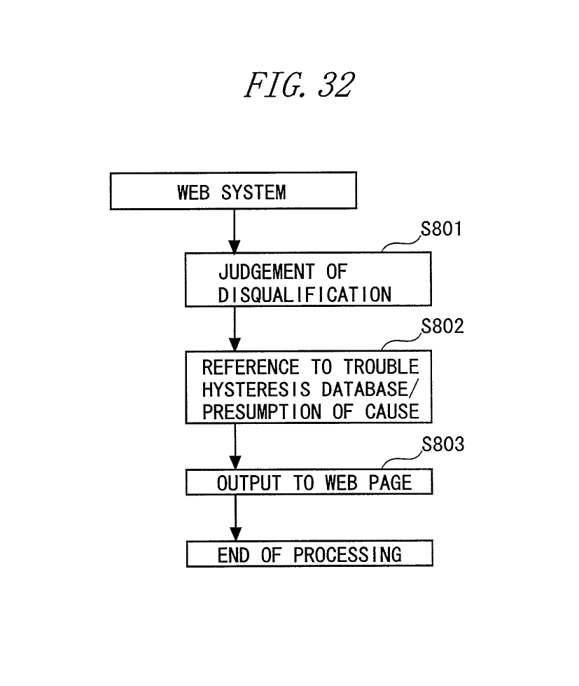

An architecture in a ninth embodiment is what a function of presuming a cause of “disqualification” as an evaluation result and a function of displaying the presumed cause on the homepage, are added to the Web server in the first embodiment. FIG. 32 is an explanatory flowchart showing the ninth embodiment.

The DB 9 or the auxiliary storage 4 of the Web server S has a trouble hysteresis database previously structured for retaining events of the evaluations of the components which were made in the past and pieces of information (cause presuming information) on the causes for the evaluation results.

The CPU 2 of the Web server S, if the evaluation result contained in the evaluation state progress state) received from the terminal device T is “disqualification” (step S801), refers to the trouble hysteresis database on the auxiliary storage 4 or the DB 9, thereby presuming a cause why the evaluation result of this time comes out (step S802).

Then, the CPU 2, when the cause is presumed, displays the presumed cause on a predetermined Web page in the homepage (step S803). Thereafter, the component suppliers accesses the homepage and thus can browse the presumed cause displayed on the homepage. The presumed cause is used as data for improving the component of the component supplier.

[Tenth Embodiment]

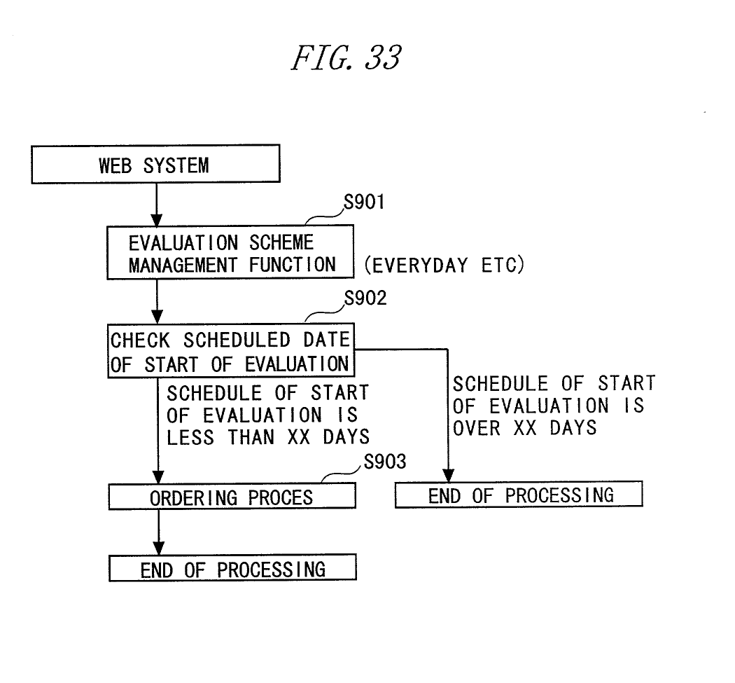

An architecture in a tenth embodiment is what a function of giving an order of an evaluation target component (sample) for the co-evaluation to the component supplier, is added to the third or seventh embodiment. FIG. 33 is an explanatory flowchart showing the tenth embodiment.

Referring to FIG. 33, the Web server S administers the valuation scheme of the co-evaluation (step S901). If it is determined that a certain component is to be co-evaluated, the Web server S reads a scheduled data of start of this evaluation from the DB 9, and judges whether a period up to the readout scheduled date of start of evaluation is less then a predetermined threshold value (step S902).

At this time, if the period up to the readout scheduled date of start of evaluation is less then the predetermined threshold value, the CPU 2 executes a process of ordering the component as a sample (step S903).

Namely, the CPU 2 creates, based on the information (e.g., the evaluation request content and the content of answer) on the co-evaluation that is stored in the DB 9, order information containing, for instance, the number of samples used for the co-evaluation, at least one delivery destination to which the samples should be delivered, contact information on each delivery destination and a scheduled date of delivering the samples to the delivery destination, and displays the order information on the homepage.

For example, the order information is displayed on the Web page that is easy to catch the eye of the component supplier, such as the category selection page P1 and the evaluation information page P2 of the homepage. With the operation described above, the component supplier delivers a designated number samples to at least one component user participating in the co-evaluation.

According to the tenth embodiment, it is feasible to omit the user's operation of ordering the samples to the component supplier.

[Eleventh Embodiment]

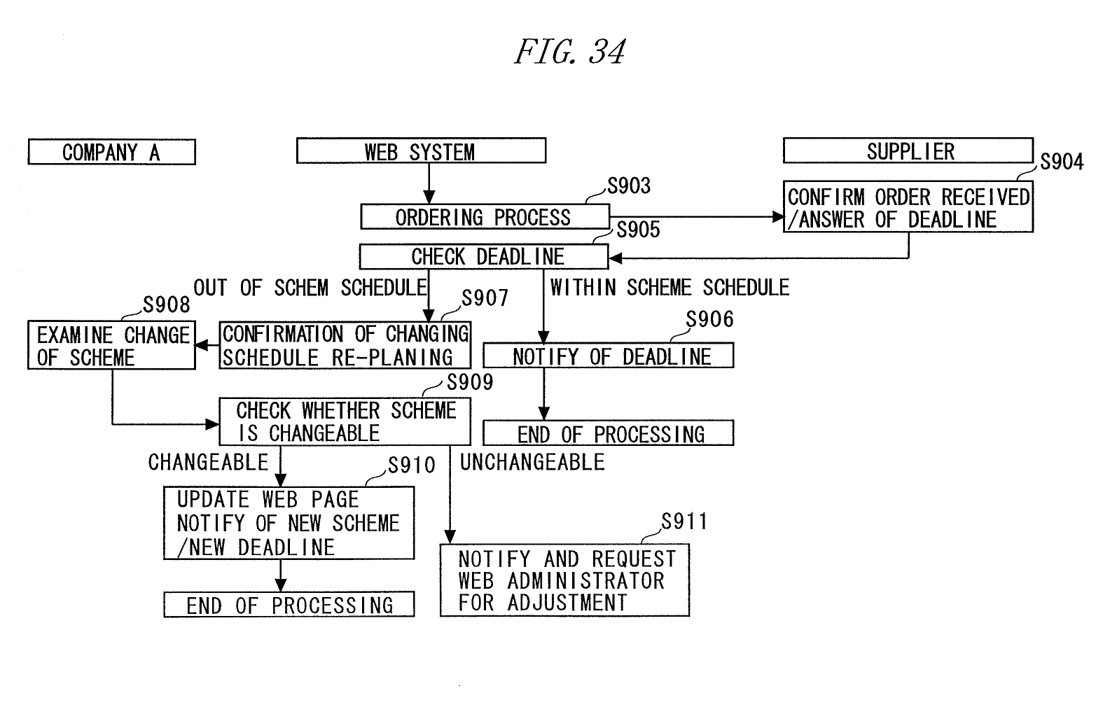

An architecture in an eleventh embodiment is what a function of displaying a delivery schedule (appointed date of delivery) and a scheme changing function of the co-evaluation based on the deadline schedule, are added to the tenth embodiment. FIG. 34 is an explanatory flowchart showing the eleventh embodiment.

As shown in FIG. 34, the order process (step S903) shown in FIG. 33 is executed, and the order information to the component supplier is displayed on the homepage. Then, the component supplier browsing the same order information confirms a receipt of the order based on the order information, and transmits an appointed date of delivery of the sample to the Web server S.

When the Web server S receives the delivery date of the sample, the CPU 2 reads the scheduled date of start of evaluation in the evaluation scheme using this sample from the DB 9, and judges whether the delivery date of the sample is before or after the scheduled date of start of evaluation (step S905).

At this time, if the delivery date is before the scheduled date of start of evaluation, the CPU 2 displays this delivery date on the homepage as in the tenth embodiment (step S906). By contrast, if the delivery date is after the scheduled date of start of evaluation, the CPU 2 displays the delivery date and a request for changing the scheduled date of start of evaluation on the homepage (step S907).

The component user as the delivery destination of the sample, when knowing the request for changing the scheduled date of start of evaluation in a way that browses the homepage by operating the terminal device T, examines whether the scheduled date of start of evaluation can be changed in accordance with the delivery date (step S908).

Then, the component user enters, in the entry box prepared on the homepage, an answer (showing whether it is changeable or not, if changeable, a changed scheduled date of start of evaluation and, if necessary, a desired delivery date) in response to the above change request, and transmits the answer to the Web server S. When the Web server S receives the answer, the CPU 2 checks whether the change contained in the answer is possible or not, and thus judges whether the scheduled date of start of evaluation can be changed (step S909).

At this time, if the scheduled date of start of evaluation can be changed, the CPU 2 rewrites the scheduled date of start of evaluation in the relevant evaluation scheme on the homepage into a new scheduled date of start of evaluation (step S910) Further, the CPU 2 notifies the component suppliers of the new scheduled date of start of evaluation and the desired delivery date by displaying the new scheduled date of start of evaluation and the desired delivery date on the homepage.

Whereas if the answer to the change request is that the scheduled date of start of evaluation can not be changed, the CPU 2 notifies the homepage administrator (the administrator of the co-evaluation system) of this purport and a request for adjustment (step S911). The administrator receiving this notification gets contact with the component supplied and makes the arrangement for the delivery date.

According to the eleventh embodiment, the CPU 2 of the Web server S judges whether the delivery date presented by the component supplier is suited to the evaluation scheme. If not suited, the CPU 2 notifies the component user of the request for changing the evaluation scheme by displaying this request on the homepage. The component user sends the answer to the Web server S through the homepage. This enables the component user to omit an execution of the process of reflecting in the homepage the scheme change due to the factor of the delivery date of the sample.

In accordance with the eleventh embodiment, the component supplier notifies the Web system of the delivery schedule, and the Web system modifies, based on the notified delivery schedule, the co-evaluation scheme and the delivery schedule as well.

[Twelfth Embodiment]

An architecture in a twelfth embodiment is a function of setting the evaluation result of the co-evaluation, which is displayed on the homepage, for component users incapable of evaluating in terms of a burden of the costs needed for the evaluation equipment and the evaluation itself in a way that enables those incapable component users to browse the evaluation result with a fee charged, and sharing profits acquired from the browse among the component users having performed the co-evaluation browsed, is added to the first embodiment.

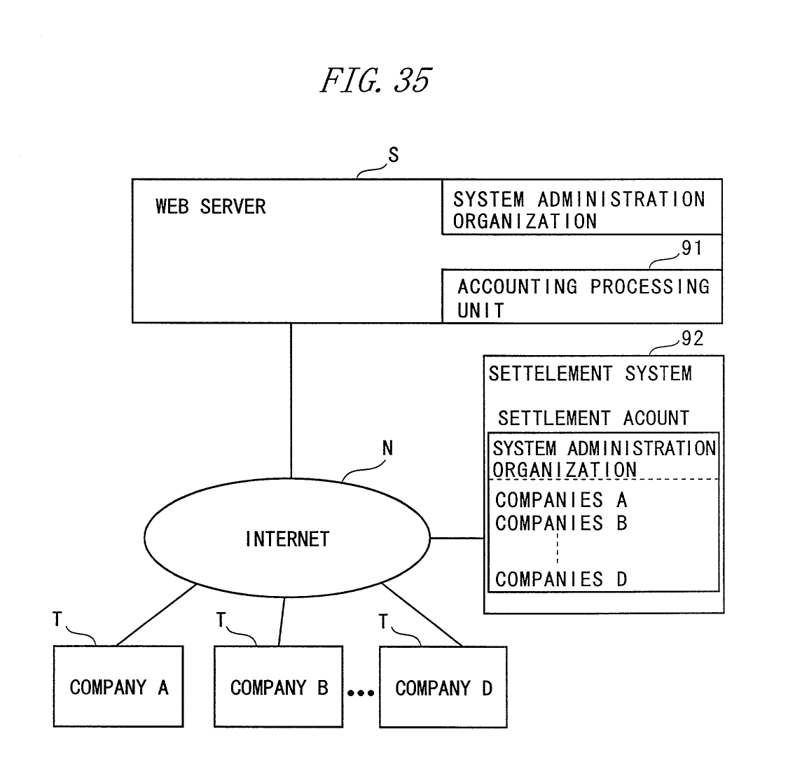

FIG. 35 is a diagram showing a system architecture in the twelfth embodiment. The system in the twelfth embodiment is different from the system in the first embodiment in terms of the following points.

(1) The Web server S has an accounting processing module 91 actualized by the CPU 2 executing the program. The CPU 2 executes the programs, whereby the Web server S functions as a creation module, a judging module, a providing module, a calculation module and a request module according to the present invention. The accounting processing module 91 corresponds to the judging module, the calculation module and the request module.

(2) A computer 92 of a settlement institution is connected to the Internet N. The computer 92 manages a settlement bank account of the administrator and settlement bank accounts of the members (the member component users: the companies A, B, C and D in the example shown in FIG. 34) of the homepage, and controls a withdrawing process from and a depositing process into each settlement bank account.

<Outline>

An outline of a settlement/accounting process on the co-evaluation alliance homepage will be explained.

(1) The administrator of the homepage determines the settlement institution such as a bank etc, and previously establishes the settlement bank accounts of the administrator and of the members. This procedure may also be conducted by documents between the administrator, the settlement institution and the members without through the Internet N.

(2) The accounting process is executed by the co-evaluation system.

(a) Operating costs of the co-evaluation alliance administration organization

Each member periodically pays a membership fee to the administrator. The administrator applies the membership fees paid to a variety of costs (e.g., the administration/operating costs for the homepage, and to maintenance/inspection costs of the Web server S) required for operating the co-evaluation system, thus administering the co-evaluation system.

An accounting system of the membership fees is that the settlement institution withdraws the membership fee of each member from the settlement bank account established in the settlement institution at an interval of a predetermined period (monthly/semiannually/annually), and deposits the withdrawn membership fees into the settlement bank account of the administrator. The withdrawing/depositing processes may also be executed by the computer 92.

(b) Accounting process when a member not participating the co-evaluation browses the evaluation result of the co-evaluation.

If a certain member browses the evaluation result of the co-evaluation on the homepage, in which this member did not participate, the administrator collects a fee for this browsing and distributes the collected fees to the respective members having implemented the co-evaluation. Hereinafter, the accounting/settlement processes in this case will be described in depth.

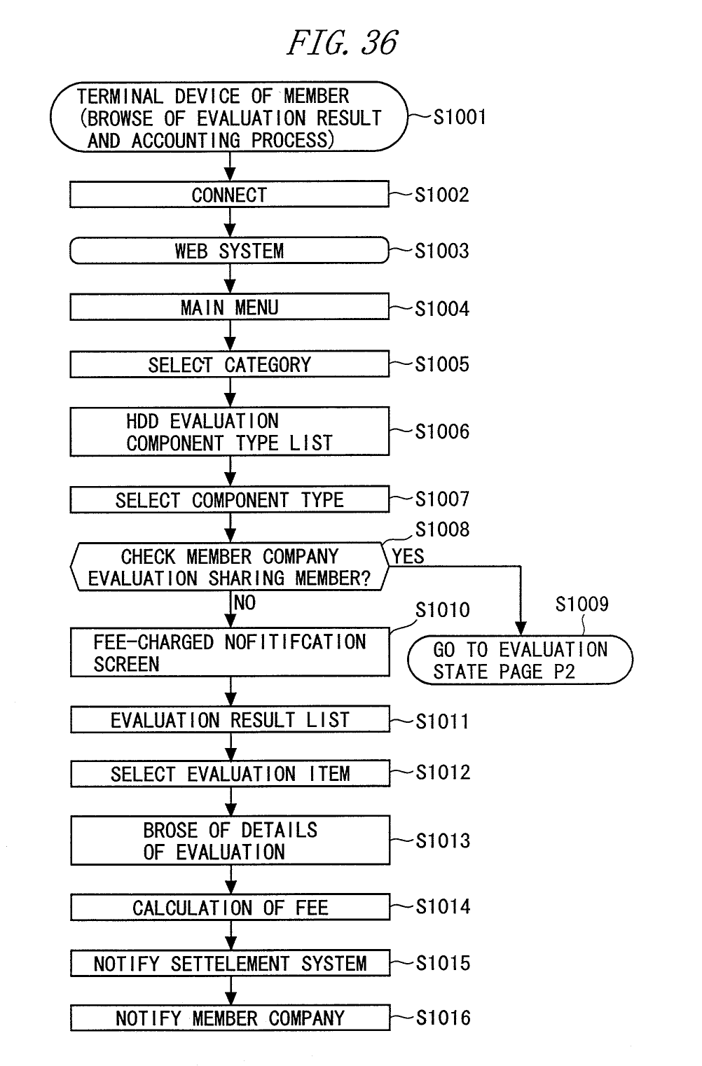

FIG. 36 is a flowchart showing the accounting/settlement process when browsing the evaluation result. Referring to FIG. 36, the component user (who did not participate in the co-evaluation: for example, the company D) desiring to browse the evaluation result, accesses the homepage via the Internet by operating the terminal device T (steps S1001˜S1003).

Then, the category selection page P1 (FIG. 5) is displayed on the display 16 of the terminal device T. The company D selects a category of the evaluation result that the company D desires to browse from the main menu displayed on the page P1 (steps S1004, S1005).

Then, as in the first embodiment, after authenticating the user, the Web server S transmits the screen data of the Web page P13 showing an evaluation component type list to the terminal device T, whereby the Web page P13 is displayed on the display 16 (step S1006).

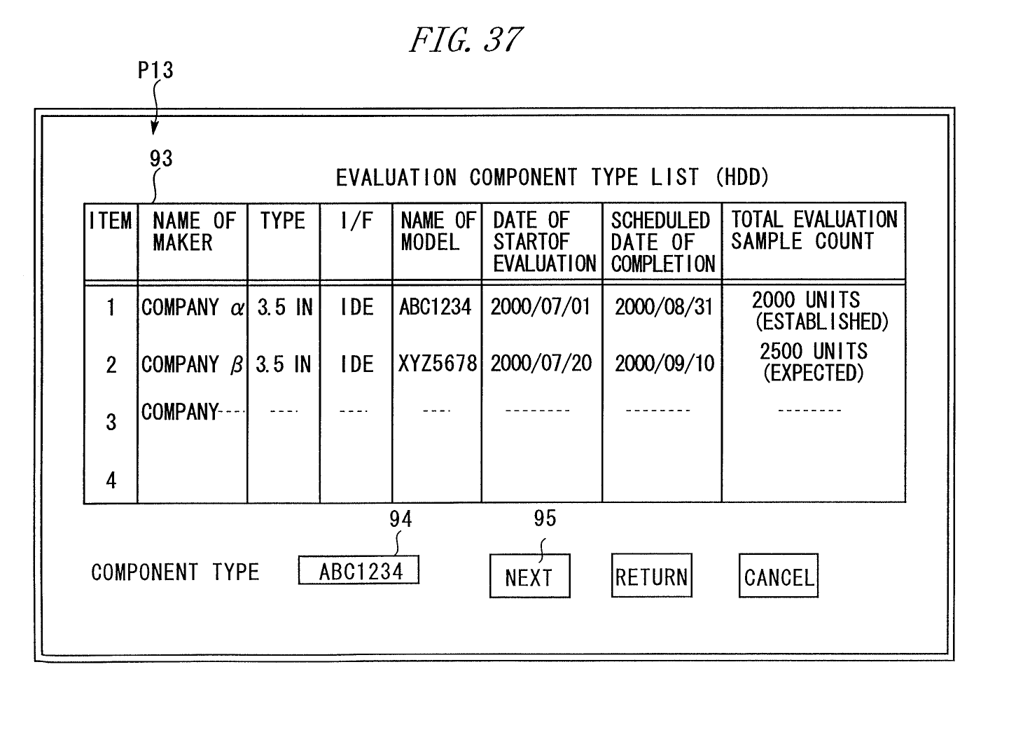

FIG. 37 shows an example of a screen display of the Web page P13. The Web page P13 contains an evaluation component type of the selected category, and buttons 94˜96. FIG. 37 shows the evaluation component type list 93 when the selected category (component type) is HDD. The evaluation component type list 93 is structured in a table format containing one or more evaluation records each consisting of data elements such as a name of maker, a type, I/F, a name of model, a date of start of evaluation, a scheduled date of completion and a total evaluation sample count.

The company D, when selecting a desire-to-browse component type (name of model), enters the selected component type (name of model) in an entry box 94, and thereafter clicks a “Next” button 95 (step S1007). Then, a result of selecting the component type is transmitted from the terminal device T to the Web server S.

When the Web server S receives the result of selection, the accounting processing module 91 of the Web server S executes a member check process, and judges whether the desire-to-browse user is a member who did not participate in the co-evaluation corresponding to the desire-to-browse evaluation result (step S1008) Namely, the accounting processing module 91 specifies an evaluation record containing the selected component type) name of model) from the evaluation component type list 93.

Next, the accounting processing module 91 reads from the DB 9 the members corresponding to the specified evaluation record, i.e., user names of the plurality of component users (evaluation assigning members) having effected the co-evaluation corresponding to the evaluation record. Subsequently, the accounting processing module 91 compares the readout user names with the user name of the desire-to-browse user (the company D) given when in the user authentication, and judges whether there is the readout user name coincident with the user name of the desire-to-browse user.

If there exists the coincident user name, the accounting processing module 91 judges that the desire-to-browse user is one of the evaluation assigning members, then creates the screen data of the evaluation state page P2 and transmits the screen data to the terminal device T concerned (step S1009). The processes after this step are the same as those in the first embodiment.

Whereas if there is no coincident user name, the accounting processing module 91 judges that the desire-to-browse user (the company D) is not the evaluation assigning member, then creates a set of screen data of a fee notification screen P14 and transmits the screen data to the terminal device T concerned. The terminal device T displays, based on the screen data received, the fee notification screen P14 on the display 16 (step S1010).

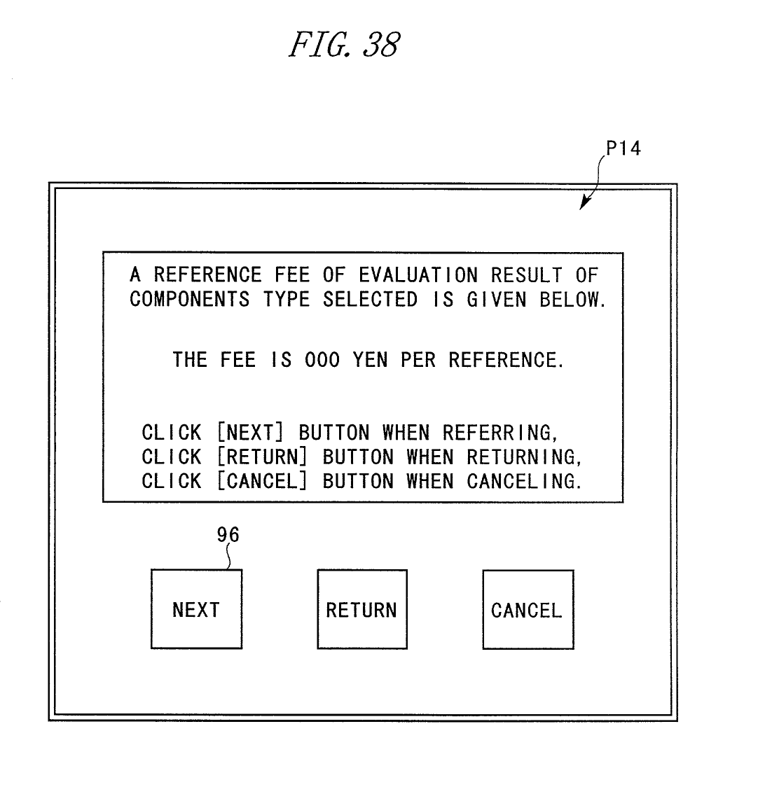

FIG. 38 is a diagram showing an example of a screen display of the fee notification screen P14. The fee notification screen 14 shows a fee in the case of referring to (browsing) the evaluation result. The company D, after confirming the fee presented, clicks a “Next” button 96.

Then, the Web server S transmits the screen data of the Web page (unillustrated) containing the evaluation result list to the terminal device T of the company D, and the evaluation result list is displayed on the display 16 (step S1011).

The evaluation result list has the same screen layout as, e.g., the display box 33 for the evaluation result shown in FIG. 21, wherein an evaluation result record 75 about the component type (name of model) selected by desire-to-browse user (the company D), is displayed.

When the company D clicks the desire-to-browse evaluation result record 75 (step S1012), the evaluation result list page P11 (FIG. 22) and the detailed result page P12 (FIG. 23), which correspond to the evaluation result record 75 clicked, are displayed on the display 16. The company D is thereby able to browse the desired evaluation result (S1013).

When finishing the browse, the accounting processing module 91 of the Web server S calculates a fee for the browse described above (step S1014). Then, the accounting processing module 91 transmits to the computer 92 of the settlement institution a settlement request saying that the calculated fee is transferred from the bank account of the company D into the bank account of the administrator (step S1015). The settlement request may also be transmitted by an E-mail to the settlement institution.

Thereafter, the accounting processing module 91 notifies the company D of fee information (accounting information) (step S1016). The company D is notified by, e.g., the E-mail.

After this process, the accounting processing module 91 calculates an amount of money shared among the evaluation assigning members (which is called [share money]) in the case of distributing the fees among the evaluation assigning members. Then, the accounting processing module 91 transmits to the computer 92 a settlement request saying that the share money is transferred from the bank account of the administrator into the bank account of each of the evaluation assigning members.

Note that in the process described above, the fee may be fixed per browsing for every component type, or a unit fee per browsing may also be calculated per component type based on the number of evaluation steps of the evaluation assigning members each assigned an evaluation of the component type concerned.

Further, it is preferable that the process of sharing the fees for browsing the evaluation result among the evaluation assigning members be executed together with the membership fee settlement process at the interval of a fixed period (e.g., monthly). Namely, an amount of money obtained by subtracting a cumulative value of the share money per month from the membership fees for one month, may be withdrawn from the bank account of each of the evaluation assigning members into the bank account of the administrator. The fee to be shared may be set to an amount of money proportional to the evaluation steps of each of the evaluation assigning companies.

According to the twelfth embodiment, each of the evaluation assigning members (implementing the co-evaluation) receive a share of the fees for browsing the evaluation result, thereby making it possible to reduce the cost for evaluating the component. Moreover, the member browsing the evaluation result does not evaluate the component and is therefore able to reduce the component evaluation cost. Hence, the browsing fee is set lower than the evaluation cost.

Further, even the component users who can not effect the component evaluation at all under various circumstances become the homepage members and are able to obtain the evaluation result. The component users who only browse the revaluation result, with the result that the number of members from whom the browsing fees are collected, can be increased. Accordingly, it is feasible to increase the amount of money shared among the valuation assigning members and reduce the component evaluation costs of the evaluation assigning members.

Note that the following architectures (functions) may also be adopted as substitutes for the architecture in the twelfth embodiment.

(A) The browse of the evaluation result is charged a fee with respect to all the members irrespective of whether the members participate in the co-evaluation. The browsing fees obtained are allotted as an evaluation operating cost among the evaluation assigning members corresponding to the browsed evaluation result in accordance with the number of evaluation steps of each evaluation assigning member

(B) The membership fee of each of the members (non-participation members) who do not participate in the co-evaluation at all, is set higher than the membership fee of each of the members (participation members) possible of participating in the co-evaluation, and the membership fees of the non-participation members are shared among the evaluation assigning members.

What is claimed is:

1. A co-evaluation system for a component of an electronic device, comprising:
a first terminal device used by a first component user who evaluates said component of said electronic device; and
a second terminal device used by a second component user,
wherein said first terminal device transmits to a network a co-evaluation request containing an evaluation scheme of a specified component that is effected by said first component user,
said second terminal device receives the co-evaluation request via said network, and transmits to said network an answer to the co-evaluation request containing the evaluation scheme of said specified component that is effected by said second component user,
said first terminal device receives the answer via the network, and transmits to the network an evaluation result of the specified component on the basis of the co-valuation request by said first component user,
said second terminal device receives from the network the evaluation result of said specified component by said first component user, and transmits to the network the evaluation result of said specified component based on the co-evaluation request by said second component user, and
said first terminal device receives the evaluation result of said specified component by said second component user from the network.

2. A server for a co-evaluation of a component of an electronic device, comprising:
a module for receiving a co-evaluation request containing an evaluation scheme of a specified evaluation scheme that is effected by a first component user from a first terminal device used by said component user for evaluating said component of said electronic device;
a module for transmitting the co-evaluation request to a second terminal device used by a second component user;
a module for receiving from said second terminal device an answer to the co-evaluation request containing the evaluation scheme of said specified component that is effected by said second component user;
a module for transmitting the answer to said first terminal device;
a module for receiving the evaluation result of said specified component based on the co-evaluation request by said first component user from said first terminal device;
a module for transmitting the evaluation result of said specified component by said first component user to said second terminal device;
a module for receiving from said second terminal device the evaluation result of said specified component based on the co-evaluation request by said second component user; and
a module of transmitting the evaluation result of said specified component by said second component user to said first terminal device.

3. A server according to claim 2, wherein said server receives and displays on a homepage the co-evaluation request, the answer, the evaluation result of said specified component by said first component user, and the evaluation result of said specified component by said second component user.

4. A server according to claim 2, wherein said server, when receiving the evaluation result of said specified component by said first component user and/or the evaluation result of said specified component by said second component user, makes a general judgement of the co-evaluation based on a predetermined condition, and notifies said first and second component users of a result of this general judgement.

5. A server according to claim 3, wherein said server displays the result of the general judgement on the homepage.

6. A server according to claim 2, wherein said server, when obtaining the evaluation scheme of said first component user by accessing a first database for storing the evaluation scheme of said component that is effected by said first component user, notifies at least said second component user of the co-evaluation request containing the obtained evaluation scheme of said first component user.

7. A server according to claim 5, wherein said server displays the co-evaluation request on the homepage.

8. A server according to claim 2, wherein said server stores a schedule of completion of evaluation in the evaluation scheme of said first component user, and, if judging that the evaluation is not completed up to the schedule of completion of evaluation stored, notifies said first component user of a prompting demand for the evaluation.

9. A server according to claim 7, wherein said server displays the prompting demand on the homepage.

10. A server according to claim 2, wherein said server stores the schedule of completion of evaluation in the evaluation scheme of said first component user, and, if judging that the evaluation is not completed up to the schedule of completion of evaluation stored, notifies said second component user of a request for implementing the evaluation that should be implemented by said first component user.

11. A server according to claim 9, wherein said server displays the implementation request on the homepage.

12. A server according to claim 2, wherein said server, if the evaluation result of said specified component that is effected by said first component user or said second component user, shows disqualification, notifies a component supplier of a request for an improvement.

13. A server according to claim 12, said server displays the improvement request on the homepage in order for a third terminal device used by said component supplier to receive the homepage from said server and to display the improvement request.

14. A server according to claim 13, wherein said server, when receiving a measure for improvement presented by said component supplier, displays the measure for improvement on the homepage.

15. A server according to claim 13, wherein said server, when receiving a schedule till said component supplier delivers an improved component to said first component user and said second component user, displays this schedule on the homepage.

16. A server according to claim 7, wherein said server, when receiving a request for changing the evaluation scheme of said first component user from said second component user, notifies said first component user of the change request, and, when receiving a content of the change in the evaluation scheme of said first component user that is determined between said first component user and second component user, displays on the homepage the evaluation scheme of said first component user, in which the content of the change is reflected.

17. A server according to claim 2, wherein said server, if the evaluation result of said first component user or said second component user shows the disqualification, displays a presumed cause of the disqualification on the homepage, and
said third terminal device used by said supplier of said specified component receives the homepage from said server and displays the presumed cause thereon.

18. A server according to claim 2, wherein said server based on the evaluation scheme displayed on the homepage, issues an order sheet of said evaluation target component in the evaluation scheme to said component supplier.

19. A server according to claim 16, wherein said server, when receiving a delivery date of said evaluation target component that is presented from said supplier in response to the order sheet, judges whether the delivery date accords with the evaluation scheme, and, if it does not accord, notifies said first component user and/or said second component user effecting the evaluation based on the evaluation scheme, of a request for changing the evaluation scheme.

20. A server according to claim 18, said server, when receiving the content of the change in the evaluation scheme from said component user receiving the change request, updates the evaluation scheme displayed on the homepage on the basis of the content of the change.

21. A method of providing a homepage by a server, comprising steps of:
creating the homepage on which a result of a co-evaluation of a component of an electronic device that is effected by a plurality of component users;
judging, when receiving a request for browsing the result of the co-evaluation from a homepage browsing user, whether this browsing user corresponds to any one of said plurality of component users having effected the co-evaluation;
providing, if the browsing user does not correspond to any one of said plurality of component users, the browsing user with the homepage with a fee charged;
calculating an amount of money when the fees obtained by providing the homepage are shared among said component users in accordance with a proportion of how much each of said component users is assigned the co-evaluation; and
requesting a settlement institution to pay the calculated amount of money to said plurality of component users.

22. A server comprising:
a creation module for creating the homepage on which a result of a co-evaluation of a component of an electronic device that is effected by a plurality of component users;
a judging module for judging, when receiving a request for browsing the result of the co-evaluation from a homepage browsing user, whether this browsing user corresponds to any one of said plurality of component users having effected the co-evaluation;
a providing module for providing, if the browsing user does not correspond to any one of said plurality of component users, the browsing user with the homepage with a fee charged;
a calculation module for calculating an amount of money when the fees obtained by providing the homepage are shared among said component users in accordance with a proportion of how much each of said component users is assigned the co-evaluation; and
a request module for requesting a settlement institution to pay the calculated amount of money to said plurality of component users.
